(19) United States
(12) Patent Application Publication
(10) Pub. No.: US 2026/0163481 A1
(43) Pub. Date: Jun. 11, 2026

(54) VOLTAGE CONTROL DEVICE AND SWITCHED CAPACITOR SYSTEM FOR MODULATING GATE-SOURCE VOLTAGE

(71) Applicant: INDUSTRIAL TECHNOLOGY RESEARCH INSTITUTE, Hsinchu (TW)

(72) Inventors: Ching-Ran LEE, Zhudong Township (TW); Jia-Ming ZHANG, Taipei City (TW); Le-Ren CHANG-CHIEN, Tainan City (TW); Che-Min KUNG, Zhubei City (TW); Ho-Cheng LIN, Taoyuan City (TW)

(73) Assignee: INDUSTRIAL TECHNOLOGY RESEARCH INSTITUTE, Hsinchu (TW)

(21) Appl. No.: 19/292,238

(22) Filed: Aug. 6, 2025

(30) Foreign Application Priority Data
Dec. 11, 2024 (TW) 113148142

(51) Int. Cl. H02M 3/07; H02M 3/158

(52) U.S. Cl. CPC H02M 3/07; H02M 3/1586

(57) ABSTRACT

A voltage control device and a switched capacitor system are provided. The voltage control device is applied to a switched capacitor circuit, the switched capacitor circuit includes multiple switch elements and multiple capacitors. The switch elements include at least a first switch element. The first switch element receives a gate-source voltage to control its conduction degree. The voltage control device performs a stage time-varying modulation or a continuous time-varying modulation on the gate-source voltage of the first switch element. During the period for the first switch element being turned-on, the gate-source voltage of the first switch element is modulated as multiple target voltages at multiple time points in response to a set of switch control signals. The voltage control device is disposed in the switched capacitor system.

This application claims the benefit of Taiwan application Serial No. 113148142, filed Dec. 11, 2024, the disclosure of which is incorporated by reference herein in its entirety.

### TECHNICAL FIELD

The technical field relates to a voltage control device and a switched capacitor system for modulating a gate-source voltage of a switch element.

### BACKGROUND

In power conversion technology, switched capacitor circuits are widely used to provide power conversion for electronic devices. Switched capacitor circuits use small capacitors to convert energy and regulate the voltage of electronic devices, without magnetic components such as transformers and inductors, thereby reducing circuit complexity. Furthermore, the switched capacitor circuit can be integrated into a chip to reduce the overall volume.

During the voltage conversion (including voltage-boost conversion or voltage-buck conversion) performed by a switched capacitor circuit, power supplies or capacitors of different voltages may be directly connected in parallel. The component with a higher voltage may charge the component with a lower voltage, and a relatively large current spike may be generated at the moment when the above components are connected in parallel. The current spikes cause power loss in circuit components and generate a large amount of heat, which in turn affects the stability and conversion efficiency of the power supply of the switched capacitor circuit, which may damage the circuitry components.

Therefore, it is desirable to have a current spike suppression mechanism which is applied to the switched capacitor circuit or the switched capacitor system.

### SUMMARY

According to one embodiment of the present disclosure, a voltage control device is provided. The voltage control device is applied to a switched capacitor circuit, wherein the switched capacitor circuit comprises a plurality of switch elements and a plurality of capacitors, the switch elements comprise at least a first switch element, the first switch element receives a gate-source voltage to control the conduction degree of the first switch element. The voltage control device performs at least a stage time-varying modulation or a continuous time-varying modulation on the gate-source voltage of the first switch element, and during the period when the first switch element is turned-on, the gate-source voltage of the first switch element is modulated to a plurality of target voltages at a plurality of time points in response to a set of switch control signals.

According to another embodiment of the present disclosure, a switched capacitor system is provided. The switched capacitor system comprises a plurality of switch elements which comprising a first switch element for receiving a gate-source voltage to control a conduction degree of the first switch element, a plurality of capacitors and a switch control signal generator for generating a set of switch control signals, and each of the switch control signals has a form of high-low voltage, and a voltage control device. The switch control signals are provided to the voltage control device, and the voltage control device performs a stage time-varying modulation on the gate-source voltage of the first switch element in response to the switch control signals.

According to still another embodiment of the present disclosure, a switched capacitor system is provided. The switched capacitor system comprises a plurality of switch elements which comprising a first switch element for receiving a gate-source voltage to control a conduction degree of the first switch element, a plurality of capacitors and a switch control signal generator for generating a set of switch control signals, and each of the switch control signals has a form of high-low voltage, and a voltage control device comprising an analog charge circuit. The switch control signals are provided to the voltage control device, and the voltage control device performs a continuous time-varying modulation on the gate-source voltage of the first switch element in response to the switch control signals.

### BRIEF DESCRIPTION OF THE DRAWINGS

FIG. 1A is a circuit diagram of a switched capacitor circuit 1000 according to an embodiment of the present disclosure.

FIG. 1B is a schematic diagram of capacitors C1 and C2 of the switched capacitor circuit 1000 being connected in series for performing serial-charging.

FIG. 1C is a schematic diagram of capacitors C1 and C2 of the switched capacitor circuit 1000 being connected in parallel for performing parallel-discharging.

FIG. 1D and FIG. 1E are schematic diagrams showing a switched capacitor circuit 2000 of another embodiment performing voltage-boost conversion.

FIG. 2A is a schematic diagram showing the switched capacitor circuit 1000 of the present disclosure performs a two-stage modulation.

FIG. 2B is a waveform diagram of the current change corresponding to the two-stage modulation of the gate-source voltage Vgs of the switch element S1.

FIG. 3 is a schematic diagram showing a switched capacitor circuit 1000 provided with a voltage control device 100.

FIG. 4A-1 is a functional block diagram of a switched capacitor system 1001 of the present disclosure.

FIG. 4A-2 is a circuit diagram of an embodiment of a voltage control device 100 provided in the switched capacitor circuit 1000 of FIG. 3.

FIG. 4B is a waveform diagram of the switch control signal CLK, the multi-stage control signal CLK_a and the multi-stage control signal CLK_b of the voltage control device 100 of FIG. 4A.

FIG. 4C a waveform diagram of the gate-source voltage Vgs of the switch element S1 when the voltage control device 100 implements the two-stage modulation.

FIG. 4D-1 is a schematic diagram of the voltage control device 100 operating in the first transition state.

FIG. 4D-2 is a schematic diagram showing the voltage control device 100 operating in the second transition state.

FIG. 4D-3 is a schematic diagram showing the voltage control device 100 operating in the third transition state.

FIG. 5A is a circuit diagram of a voltage control device 101 according to another embodiment of the present disclosure.

FIG. 5B shows the waveforms of the switch control signal CLK, the multi-stage control signals CLK_a, CLK_b and CLK_c of the voltage control device 101 of FIG. 5A.

FIG. 5C a waveform diagram of the gate-source voltage Vgs of the switch element S1 when the voltage control device 101 implements three-stage modulation.

FIG. 5D-1 is a schematic diagram showing the voltage control device 101 operating in the first transition state.

FIG. 5D-2 is a schematic diagram showing the voltage control device 101 operating in the second transition state.

FIG. 5D-3 is a schematic diagram showing the voltage control device 101 operating in the third transition state.

FIG. 5D-4 is a schematic diagram showing the voltage control device 101 operating in the fourth transition state.

FIG. 6A is a circuit diagram of a voltage control device 102 according to another embodiment of the present disclosure.

FIG. 6B a waveform diagram of the switch control signal CLK and the multi-stage control signals CLK_a, CLK_b, CLK_c and CLK_d of the voltage control device 102 of FIG. 6A.

FIG. 6C a waveform diagram of the gate-source voltage Vgs of the switch element S1 when the voltage control device 102 implements four-stage modulation.

FIG. 6D-1 is a schematic diagram showing the voltage control device 102 operating in the first transition state.

FIG. 6D-2 is a schematic diagram showing the voltage control device 102 operating in the second transition state.

FIG. 6D-3 is a schematic diagram showing the voltage control device 102 operating in the third transition state.

FIG. 6D-4 is a schematic diagram showing the voltage control device 102 operating in the fourth transition state.

FIG. 6D-5 is a schematic diagram showing the voltage control device 102 operating in the fifth transition state.

FIG. 7 is a functional block diagram of the switched capacitor system 1002 of the present disclosure.

FIG. 8A is a schematic diagram of a voltage control device 200 according to another embodiment of the present disclosure.

FIG. 8B is a schematic diagram showing the operation of the voltage control device 200 in FIG. 8A.

FIG. 8C is a waveform diagram of the continuous time-varying modulation of the gate-source voltage Vgs of the switch element S1, when the voltage control device 200 is operating.

FIG. 8D is a waveform diagram of the corresponding current change when the gate-source voltage Vgs of the switch element S1 is continuously time-varying modulated.

FIG. 9A is a circuit diagram of a voltage control device 201 according to another embodiment of the present disclosure.

FIG. 9B is a schematic diagram showing the operation of the voltage control device 201 in FIG. 9A.

FIG. 9C is a waveform diagram of the continuous time-varying modulation of the gate-source voltage Vgs of the switch element S1 when the voltage control device 201 is operating.

FIG. 9D is a waveform diagram of the current change corresponding to the continuous time-varying modulation of the gate-source voltage Vgs of the switch element S1.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

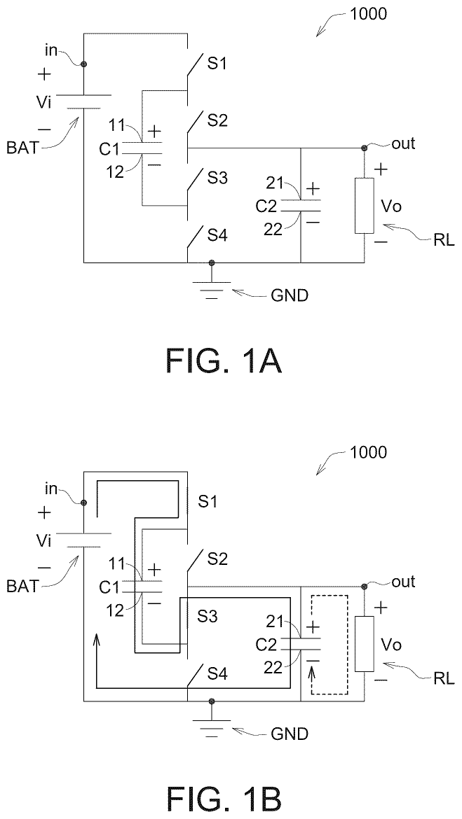

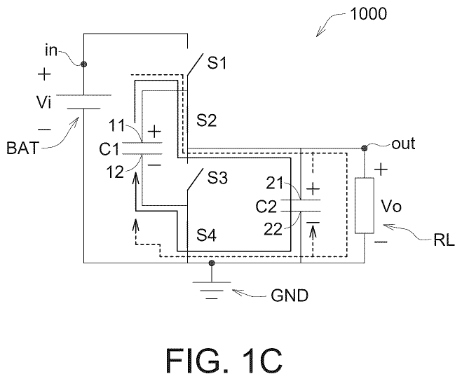

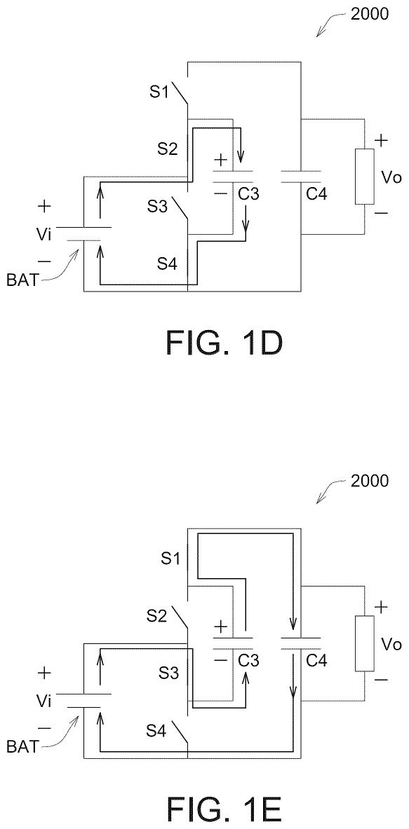

Referring to FIG. 1A, which shows a circuit diagram of a switched capacitor circuit 1000 according to an embodiment of the present disclosure. The switched capacitor circuit 1000 has an input terminal “in” and an output terminal “out”. The input terminal “in” of the switched capacitor circuit 1000 is coupled to a power supply V_SRC, and the power supply V_SRC provides an input voltage Vi. The output terminal “out” of the switched capacitor circuit 1000 is coupled to a load RL. The switched capacitor circuit 1000 comprises a plurality of switch elements and a plurality of capacitors. In this embodiment, the switched capacitor circuit 1000 comprises four switch elements S1-S4 and two capacitors C1 and C2. The capacitor C1 is used as an input capacitor, the capacitor C2 is used as an output capacitor, and the switch elements S1-S4 are used to control the capacitors C1 and C2 to be connected in series or in parallel.

The switch element S1 is coupled to the input terminal “in” and the terminal 11 of the capacitor C1. The switch element S2 is coupled to the output terminal “out” and the terminal 11 of the capacitor C1. The switch element S3 is coupled to the output terminal “out” and the terminal 12 of the capacitor C1. The switch element S4 is coupled to the ground terminal GND and the terminal 12 of the capacitor C1. The terminal 21 of the capacitor C2 is coupled to the output terminal “out”, the switch element S2 and the switch element S3. The terminal 22 of the capacitor C2 is coupled to the ground GND and the switch element S4. The capacitor C2 is connected in parallel to the load RL. The switched capacitor circuit 1000 controls the switch elements S1-S4 to be turned-on or turned off, thereby controlling the capacitors C1 and C2 to be connected in series or in parallel, so as to perform voltage-buck conversion on the input voltage Vi provided by the power supply V_SRC.

The switched capacitor circuit 1000 can operate in a first mode and a second mode during the voltage-buck conversion. Please refer to FIG. 1B, which shows a schematic diagram of capacitors C1 and C2 of the switched capacitor circuit 1000 being connected in series for performing serial-charging. The capacitors C1 and C2 connected in series, are serial-charged, which refers to the first mode of voltage-buck conversion. The switched capacitor circuit 1000 controls the switch elements S1 and S3 to be turned-on and the switch elements S2 and S4 to be turned off. At this time, the capacitors C1 and C2 are connected in series, and the voltages of the capacitors C1 and C2 are summed up. The capacitors C1 and C2 are powered by the power supply V_SRC (i.e., receiving electrical energy from the power supply V_SRC).

Next, please refer to FIG. 1C, which shows a schematic diagram of capacitors C1 and C2 of the switched capacitor circuit 1000 being connected in parallel for performing parallel-discharging. The switched capacitor circuit 1000 controls the switch elements S1 and S3 to be turned off and the switch elements S2 and S4 to be turned-on. At this time, the capacitors C1 and C2 are connected in parallel, and the capacitors C1 and C2 supply power to the load RL. Accordingly, the power of the power supply V_SRC is provided to the load RL through the capacitors C1 and C2. The input voltage Vi provided by the power supply V_SRC is reduced to the output voltage Vo, which refers to the second mode of voltage-buck conversion.

On the other hand, please refer to FIG. 1D and FIG. 1E, which are schematic diagrams showing a switched capacitor circuit 2000 of another embodiment performing voltage-boost conversion. Similar to the two modes of the voltage-buck conversion of the switched capacitor circuit 1000 in the embodiment of FIGS. 1B and 1C, the voltage-boost conversion of the switched capacitor circuit 2000 in this embodiment also has a first mode and a second mode. More specifically, the switched capacitor circuit 2000 comprises capacitors C3 and C4, and the switched capacitor circuit 2000 can operate in two modes: the first mode is that the power supply V_SRC provides the input voltage Vi to charge the capacitor C3, and the second mode is that the power supply V_SRC and the capacitor C3 are connected in series to discharge C4. In the first mode of parallel charging operation, the switched capacitor circuit 2000 can control the capacitor C3 to receive power from the power supply V_SRC. In serial-discharge operation of the second mode, the switched capacitor circuit 2000 can control the power supply V_SRC and the capacitor C3 to be connected in series, so as to supply power to C4 and the load RL; at this time, the voltages of the power supply V_SRC and the capacitor C3 are summed up. Furthermore, the input voltage Vi provided by the power supply V_SRC is boosted to the output voltage Vo, which is a boost-conversion.

The following describes the mechanism of voltage-buck conversion based on the switched capacitor circuit 1000 of the embodiment of FIGS. 1A-1C. In the first mode of the voltage-buck conversion, capacitors C1 and C2 are powered by power supply V_SRC, and power supply V_SRC is directly connected to capacitors C1 and C2; in the second mode of the voltage-buck conversion, capacitors C1 and C2 supply power to load RL, and capacitors C1 and C2 are directly connected. When direct connection initially occurs, the component with higher voltage among the power supply V_SRC, capacitors C1 and C2 will charge the component with lower voltage. The amount of charging current depends on two factors: (1) the voltage between the component serving to charge and the component being discharged; and (2) the total resistance of the charging loop formed by the component serving to charge and the component being discharged. If the above voltage is high and the total resistance is low, a current of short-term and high-flow will be formed, which is a current spike. In order to suppress the current spike, the present disclosure sets the gate-source voltage value and the time point for applying such a voltage respectively, when the switch elements S1-S4 are scheduled to enter the turned-on state, so as to control the equivalent turned-on resistance of the switch elements S1-S4 when turned-on, thereby reducing the current amount of the current spike.

More specifically, each of the switch elements S1-S4 of the switched capacitor circuit 1000 is, for example, an N-type metal oxide semiconductor (NMOS) transistor. The control mechanism of the switched capacitor circuit 1000 is to control the gate-source voltage Vgs of each transistor of the switch elements S1-S4. The “gate-source voltage Vgs” described herein is defined as: the voltage difference between the gate “g” and the source “s” of each transistor of the switch elements S1-S4. The turned-on state of the switch elements S1-S4 (including the time point for being turned-on and the equivalent turned-on resistance Ron) depends on the gate-source voltage Vgs of each of the switch elements S1-S4. Taking the switch element S1 as an example, when the gate-source voltage Vgs of the switch element S1 is higher than the threshold voltage Vth of the NMOS transistor, the switch element S1 is turned-on. Moreover, the equivalent turned-on resistance Ron when being turned-on is inversely proportional to the difference between the gate-source voltage Vgs and the threshold voltage Vth, as shown in equation (1):

$$Ron = \frac{L}{μ Cox ( Vgs - Vth ) W} \qquad ( 1 )$$

When the gate-source voltage Vgs of the switch element S1 is a lower voltage, the switch element S1 has a higher equivalent turned-on resistance Ron. At this time, the current flowing through the switch element S1 is lower, thereby achieving the effect of suppressing current spikes. In contrast, when the gate-source voltage Vgs of the switch element S1 is a higher voltage, the switch element S1 has a lower equivalent turned-on resistance Ron, so as to reduce the voltage drop, and hence the switched capacitor circuit 1000 has a higher output voltage Vo to achieve higher output power and better voltage conversion efficiency.

In the control mechanism provided by the switched capacitor circuit 1000, a voltage control device is provided to perform multi-stage modulation on the gate-source voltage Vgs of the switch element S1. At the beginning of state transition, before the current spike occurs, the gate voltage Vg is modulated to a lower voltage, so that the switch element S1 has a higher equivalent turned-on resistance Ron to suppress the current spike. After the voltage between the elements serving to charge and the elements being charged is reduced, the gate-source voltage Vgs can be modulated to a higher voltage, so that the switch element S1 has a lower equivalent turned-on resistance Ron to reduce the voltage drop, and hence the switched capacitor circuit 1000 can achieve a higher output power and better voltage conversion efficiency.

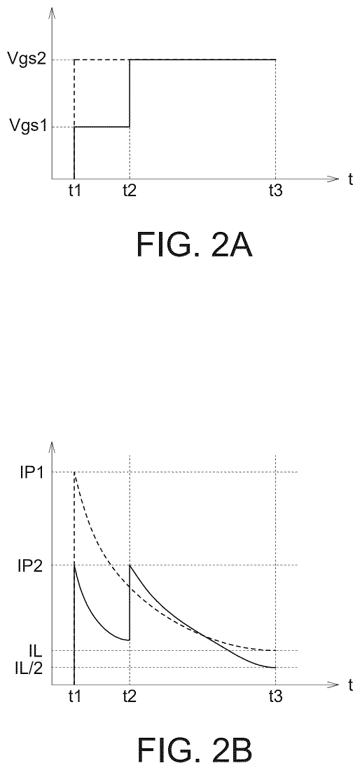

Please refer to FIG. 2A, which is a schematic diagram showing the switched capacitor circuit 1000 of the present disclosure performs a two-stage modulation. The switched capacitor circuit 1000 performs a two-stage modulation on the gate-source voltage Vgs of one or more of the switch elements S1-S4. The following description takes the switch element S1 as an example. The two-stage modulation performed by the switched capacitor circuit 1000 comprises a first stage and a second stage, as shown by the solid line portion of the corresponding relation-line between the gate-source voltage Vgs and the time t in FIG. 2A. The period from time point t1 to time point t2 is the first stage of the two-stage modulation, and the period from time point t2 to time point t3 is the second stage of the two-stage modulation. The first stage is in response to the initial stage of the current spike (for example, the initial stage of the transition from the serial-connection of the capacitors C1 and C2 to the parallel-connection, or the initial stage of the transition from the parallel-connection of the capacitors C1 and C2 to the serial-connection). In the first stage, the switched capacitor circuit 1000 modulates the gate-source voltage Vgs of the switch element S1 to a lower target voltage Vgs1. In the second stage, the current amount of the current spike has been reduced to a very low level, so the gate-source voltage Vgs is modulated to a higher target voltage Vgs2, and the switch element S1 has a lower equivalent turned-on resistance Ron. The absolute value of the target voltage Vgs2 is higher than the absolute value of the target voltage Vgs1.

Please refer to a comparative example. This comparative example only performs a single-stage control for the gate-source voltage Vgs, which is different from the two-stage modulation performed by the switched capacitor circuit 1000 of the present disclosure. The single-stage control performed in this comparative example is shown as the dotted line portion of the relation-line between the gate-source voltage Vgs and the time t shown in FIG. 2A. In this comparative example, at time point t1, the gate-source voltage Vgs is directly increased to a target voltage Vgs2 with a higher voltage value to turn on the switch element S1. Furthermore, during the single period from the time point t1 to the time point t3, the gate-source voltage Vgs is maintained at Vgs2.

Next, please refer to FIG. 2B, which is a waveform diagram of the current change corresponding to the two-stage modulation of the gate-source voltage Vgs of the switch element S1. At the time point t1 of the first stage, at the beginning of the current spike, the current of the switch element S1 has a peak value IP2. Then, the current of the switch element S1 gradually decreases. At the time point t2 of the second stage, in response to the gate-source voltage Vgs being modulated to a higher target voltage Vgs2, the current of the switch element S1 rises again to a peak value IP2. Then, the current of the switch element S1 gradually decreases, until decreasing to the lower limit value IL/2 at time point t3.

Referring to the aforementioned comparative example, this comparative example only performs a single-stage control for the gate-source voltage Vgs. At time point t1, the gate-source voltage Vgs is directly increased to the target voltage Vgs2. Therefore, the energy of the current spike is more concentrated. At time point t1, the current spike of the switch element S1 can reach a peak value IP1 (as shown by the dotted line portion of the corresponding relation-line for the current and time t in FIG. 2B).

Different from the aforementioned comparative example, the switched capacitor circuit 1000 of the present disclosure implements two-stage modulation for the gate-source voltage Vgs, and can distribute the current spike into two stages, as shown in the solid line portion of the corresponding relation-line for the current and time t in FIG. 2B. The peak values IP2 of the current spikes in each of the two stages is much smaller than the peak value IP1 of this comparative example (the peak value IP2 of the current spike of the switched capacitor circuit 1000 disclosed in the present disclosure is approximately 50% of the peak value IP1 of this comparative example), thereby, it can effectively suppress the current spikes.

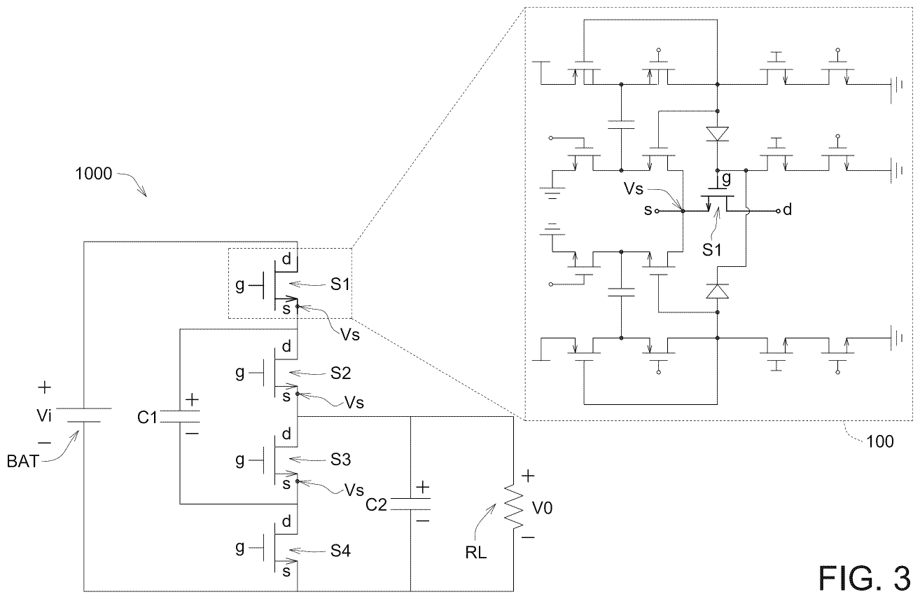

Please refer to FIG. 3, which is a schematic diagram showing a switched capacitor circuit 1000 provided with a voltage control device 100. FIG. 3 takes the switch element S1 as an example to illustrate the operation of the voltage control device 100. The voltage control device 100 is used to control the voltage difference between the gate “g” and the source “s” of the switch element S1 (such as the “gate-source voltage Vgs” mentioned above). In this embodiment, the switched capacitor circuit 1000 may be provided with four voltage control devices corresponding to the switch elements S1-S4 respectively (the voltage control device for controlling the switch elements S2-S4 is not shown in FIG. 3) to control the gate-source voltage Vgs of each of the switch elements S1-S4.

The source “s” of the transistors of the switch elements S1-S3 of the switched capacitor circuit 1000 are often in a floating state, and their respective source “s” may be at an unspecified potential Vs. In response to the above situation, the voltage control device 100 of the switch element S1 (and the respective voltage control devices of the switch elements S2-S4 which are not shown) needs to be able to match the potential Vs of its source “s” to provide a correct gate-source voltage Vgs. Commonly used methods comprise a bootstrap circuit or a level shift circuit, which shifts the zero potential of the voltage output by the voltage control device 100 to the potential Vs of the source of the switch element S1, so that the voltage control device 100 can shift the gate-source voltage Vgs of the switch element S1 to the target voltage, so as to correctly control the switch element S1 without being affected by the change of the source potential Vs of the switch element S1.

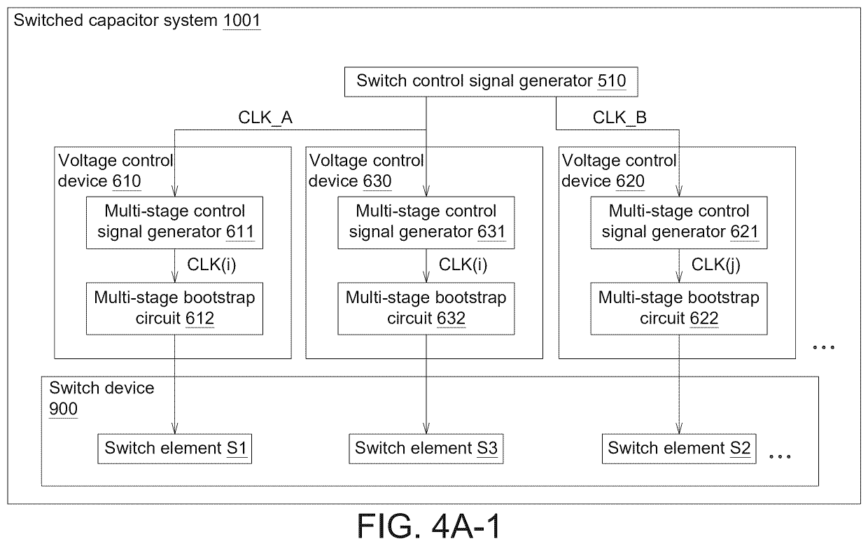

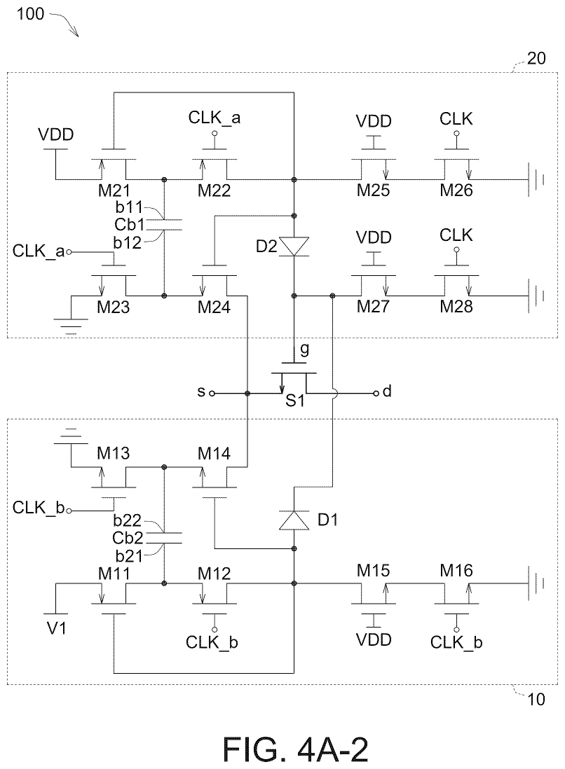

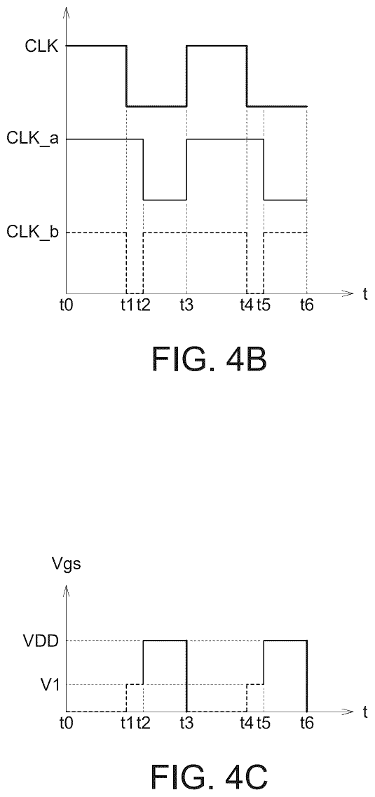

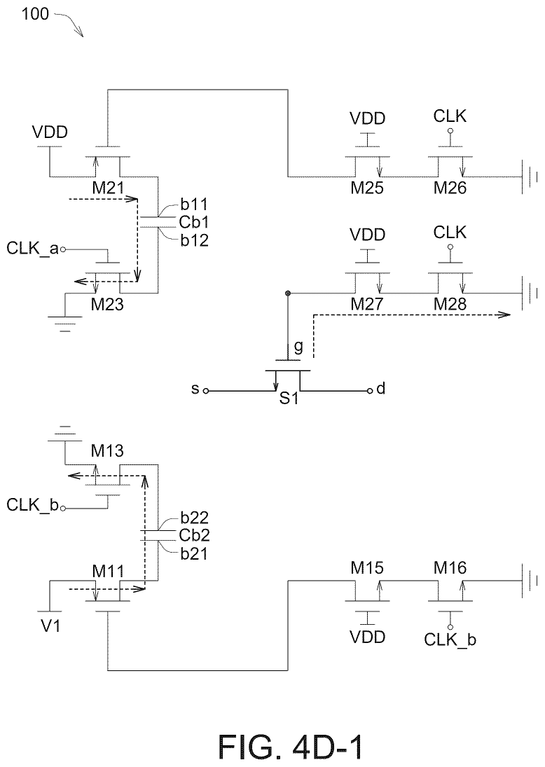

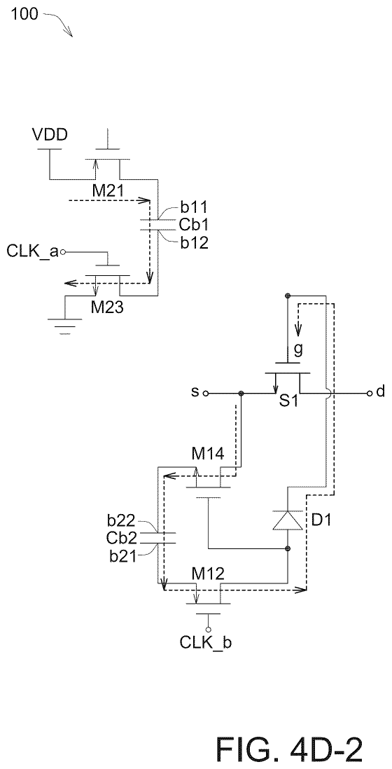

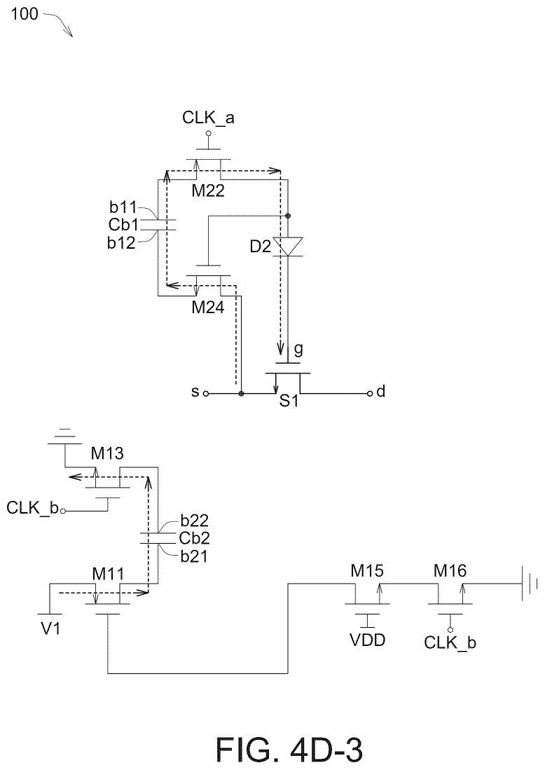

FIG. 4A-1 is a functional block diagram of a switched capacitor system 1001 of the present disclosure. The switched capacitor system 1001 of FIG. 4A-1 performs the functions of the switched capacitor circuit 1000 of FIG. 3 at a level of an overall system. The switched capacitor system 1001 comprises a switch control signal generator 510, a plurality of voltage control devices, and a switch device 900. The voltage control device, for example, comprises voltage control devices 610, 620, and 630. The switch device 900 comprises a plurality of switch elements, such as the switch elements S1-S4 shown in FIG. 3. The following description takes the switch elements S1, S2 and S3 as examples. The voltage control device 610 modulates the gate-source voltage Vgs of the switch element S1 in the switch device 900. Correspondingly, the voltage control devices 630 and 620 respectively modulate the gate-source voltage Vgs of the switch elements S3 and S2 in the switch device 900.

The voltage control device 610 comprises a multi-stage control signal generator 611 and a multi-stage bootstrap circuit 612. A single multi-stage bootstrap circuit 612 can perform multi-stage modulation of the gate-source voltage Vgs, such as two-stage modulation or three-stage modulation, etc.

Similarly, the voltage control device 630 comprises a multi-stage control signal generator 631 and a multi-stage bootstrap circuit 632, and the voltage control device 620 comprises a multi-stage control signal generator 621 and a multi-stage bootstrap circuit 622.

In operation, the switch control signal generator 510 generates a set of switch control signals CLK_A and CLK_B in the form of high-low voltages. The switch control signals CLK_A and CLK_B may have different phases. The switch control signal CLK_A is used to control the switch element S1 and the switch element S3, and the switch control signal CLK_B with a different phase is used to control the switch element S2 and the switch element S4 (the switch element S4 is not shown in this figure).

The switch control signal CLK_A is transmitted to the multi-stage control signal generator 611 and the multi-stage control signal generator 631. The multi-stage control signal generator 611 generates a multi-stage control signal CLK(i) in response to the switch control signal CLK_A, so as to provide the multi-stage control signal to the multi-stage bootstrap circuit 612. Each of the multi-stage control signals CLK(i) is a variant signal in a form of high-low voltage. Then, the corresponding transistors in the multi-stage bootstrap circuit 612 are controlled by the multi-stage control signal CLK(i), so that the transistors are adaptively turned-on or turned-off to modulate the gate-source voltage Vgs of the switch element S1. Similarly, the multi-stage control signal generator 631 generates a multi-stage control signal CLK(i) in response to the switch control signal CLK_A, which is provided to the multi-stage bootstrap circuit 632 to modulate the gate-source voltage Vgs of the switch element S3.

On the other hand, the switch control signal CLK_B of different phases is transmitted to the multi-stage control signal generator 621 of the voltage control device 620, so as to generate the multi-stage control signal CLK(j). The multi-stage control signal CLK(j) is correspondingly provided to the corresponding transistors in the multi-stage bootstrap circuit 622, so as to adaptively turn on or turn off the transistors, and thereby modulating the gate-source voltage Vgs of the switch element S2.

Please refer to FIG. 4A-2, which is a circuit diagram of an embodiment of a voltage control device 100 provided in the switched capacitor circuit 1000 of FIG. 3. This embodiment is described by taking the switch element S1 as an example. The voltage control device 100 performs two-stage modulation on the gate-source voltage Vgs of the switch element S1. The voltage control device 100 comprises a bootstrap circuit 10 and a bootstrap circuit 20 for performing a two-stage modulation of a gate-source voltage Vgs of a switch element S1. Compared to the single multi-stage bootstrap circuit 612 in FIG. 4A-1 that can perform multi-stage modulation, the present embodiment uses two bootstrap circuits (bootstrap circuit 10 and bootstrap circuit 20) to perform two-stage modulation. That is, the overall functions of the bootstrap circuit 10 and the bootstrap circuit 20 of this embodiment are equivalent to the function of the single multi-stage bootstrap circuit 612 in FIG. 4A-1.

In operation, the bootstrap circuit 10 operates in response to the multi-stage control signal CLK_b. The multi-stage control signal CLK_b is one of the plurality of multi-stage control signals CLK(i) in FIG. 4A-1. That is, the multi-stage control signal generator 611 of FIG. 4A-1 generates the multi-stage control signal CLK_b of FIG. 4A-2 in response to the switch control signal CLK_A.

More specifically, the bootstrap circuit 10 comprises six transistors M11-M16, a capacitor Cb2, and a diode D1. The transistors M13, M14, M15, and M16 are, for example, NMOS transistors, and the transistors M11 and M12 are, for example, PMOS transistors. The transistor M11 may be referred to as a “first control transistor”. The source of the transistor M11 is coupled to a voltage source (the voltage source is not shown in FIG. 4A-2) to receive the target voltage V1. The source of the transistor M12 is coupled to the drain of the transistor M11 and the terminal b21 of the capacitor Cb2.

The gate of the transistor M12 receives the multi-stage control signal CLK_b. The drain of the transistor M12 is coupled to the drain of the transistor M15, the anode of the diode D1, and the gate of the transistor M14. The drain of the transistor M14 is coupled to the source “s” of the switch element S1. The cathode of the diode D1 is coupled to the gate “g” of the switch element S1. Furthermore, a source of the transistor M14 is coupled to the terminal b22 of the capacitor Cb2 and a drain of the transistor M13. The gate of the transistor M13 receives the multi-stage control signal CLK_b. Furthermore, transistors M15 and M16 are connected in series. A drain of the transistor M15 is coupled to a drain of the transistor M12, and a gate of the transistor M15 receives the target voltage VDD. A drain of the transistor M16 is coupled to the source of the transistor M15, and a gate of the transistor M16 receives the multi-stage control signal CLK_b.

On the other hand, the bootstrap circuit 20 operates in response to the multi-stage control signal CLK_a and the switch control signal CLK. The multi-stage control signal CLK_a is one of the plurality of multi-stage control signals CLK(i) in FIG. 4A-1, and the switch control signal CLK is the switch control signal CLK_A in FIG. 4A-1. In other words, the switch control signal generator 510 of FIG. 4A-1 generates the switch control signal CLK_A and provides it as the switch control signal CLK of FIG. 4A-2. Furthermore, the multi-stage control signal generator 611 of FIG. 4A-1 generates a multi-stage control signal CLK(i) in response to the switch control signal CLK_A and provides it as the multi-stage control signal CLK_a of FIG. 4A-2.

More specifically, the bootstrap circuit 20 comprises eight transistors M21-M28, a capacitor Cb1, and a diode D2. The transistors M23, M24, M25, M26, M27, and M28 are, for example, NMOS transistors, and the transistors M21 and M22 are, for example, PMOS transistors. The circuit architecture of the bootstrap circuit 20 is similar to that of the bootstrap circuit 10. The gates of the transistors M22 and M23 receive the multi-stage control signal CLK_a. The transistor M21 may be referred to as a “second control transistor”. The source of the transistor M21 is coupled to a voltage source (the voltage source is not shown in FIG. 4A) to receive the target voltage VDD. The gate of the transistor M26 receives the switch control signal CLK. The gate of the transistor M28 receives the switch control signal CLK, the gate of the transistor M27 receives the target voltage VDD, and the drain of the transistor M27 is coupled to the cathodes of the diodes D1 and D2 and the gate “g” of the switch element S1.

In the first stage of the two-stage modulation of the gate-source voltage Vgs, the bootstrap circuit 10 is used to modulate the gate-source voltage Vgs of the switch element S1 to a target voltage V1 (the target voltage V1 of this embodiment is equal to the target voltage Vgs1 of FIG. 2A). In the second stage of the two-stage modulation, the bootstrap circuit 20 is used to modulate the gate-source voltage Vgs of the switch element S1 to the target voltage VDD (the target voltage VDD of this embodiment is equal to the target voltage Vgs2 in FIG. 2A). The detailed operation of the voltage control device 100 is described below.

FIG. 4B shows the waveforms of the switch control signal CLK, the multi-stage control signal CLK_a and the multi-stage control signal CLK_b of the voltage control device 100 of FIG. 4A. Furthermore, FIG. 4C shows the waveform of the gate-source voltage Vgs of the switch element S1 when the voltage control device 100 implements the two-stage modulation. Moreover, FIG. 4D-1 shows a schematic diagram of the voltage control device 100 operating in the first transition state. Please refer to FIGS. 4B, 4C and 4D-1. The period from time point t0 to time point t1 is the first transition state of the voltage control device 100. The switch control signal CLK, the multi-stage control signal CLK_a and the multi-stage control signal CLK_b are all high voltages.

The transistor M26 is an NMOS transistor, and thus the transistor M26 is turned-on in response to the switch control signal CLK of high voltage received at the gate. Therefore, the gate voltage of the transistor M21 is low, and the transistor M21 is turned-on. The multi-stage control signal CLK_a may be referred to as a “second multi-stage control signal”. The transistor M23 is turned-on in response to the multi-stage control signal CLK_a having a high voltage, received at the gate. The turned-on transistor M21, the capacitor Cb1, and the turned-on transistor M23 form a conducting path. The target voltage VDD received by the source of the transistor M21 is provided to the capacitor Cb1, and the capacitor Cb1 is charged to the target voltage VDD.

The multi-stage control signal CLK_b may be referred to as a “first multi-stage control signal”. The transistor M16 is turned-on in response to the multi-stage control signal CLK_b of high voltage, and the gate of the transistor M11 is turned-on at low voltage. Furthermore, the transistor M13 is turned-on in response to the multi-stage control signal CLK_b of the high voltage. The turned-on transistor M11, the capacitor Cb2, and the turned-on transistor M13 form a conducting path. The target voltage V1 received by the source of the transistor M11 is provided to the capacitor Cb2, which is to be charged to the target voltage V1.

Furthermore, the transistor M28 is turned-on in response to the high voltage switch control signal CLK, and the gate “g” potential of the switch element S1 is 0. Therefore, the gate-source voltage Vgs of the switch element S1 in the first transition state from time point t0 to time point t1 is 0V, and switch element S1 is in the turned-off state.

FIG. 4D-2 is a schematic diagram showing the voltage control device 100 operating in the second transition state. Please refer to FIGS. 4B, 4C and 4D-2. The period from time point t1 to time point t2 is the second transition state of the voltage control device 100. The switch control signal CLK and the multi-stage control signal CLK_b are reduced to a low voltage, and the multi-stage control signal CLK_a is maintained at a high voltage. The transistor M12 may be referred to as a “third control transistor”. The transistor M12 is turned-on in response to the multi-stage control signal CLK_b with a low voltage, which is received at the gate. The transistor M14 is turned-on when the gate is at a high voltage. The diode D1 may be referred to as a “first diode”. The anode of the diode D1 is at a high voltage, so the diode D1 is forward biased. The source “s” of the switch element S1 is coupled to the terminal b22 of the capacitor Cb2 through the turned-on transistor M14. The gate “g” of the switch element S1 is coupled to the terminal b21 of the capacitor Cb2 through the forward biased diode D1 and the turned-on transistor M12.

In the second transition state of the voltage control device 100, the capacitor Cb2 is charged to the target voltage V1, and the voltage between the terminal b21 and the terminal b22 of the capacitor Cb2 is the target voltage V1. Since the gate “g” and the source “s” of the switch element S1 are respectively coupled to the terminal b21 and the terminal b22 of the capacitor Cb2, the gate-source voltage Vgs of the switch element S1 is equal to the target voltage V1. As shown in FIG. 4C, in the second transition state from time point t1 to time point t2, the voltage control device 100 modulates the gate-source voltage Vgs of the switch element S1 to the target voltage V1.

FIG. 4D-3 is a schematic diagram showing the voltage control device 100 operating in the third transition state. Please refer to FIGS. 4B, 4C and 4D-3. The period from time point t2 to time point t3 is the third transition state of the voltage control device 100. The switch control signal CLK and the multi-stage control signal CLK_a are low voltages, and the multi-stage control signal CLK_b is high voltage. The transistor M22 may be referred to as a “fourth control transistor”. The transistor M22 is turned-on in response to the multi-stage control signal CLK_a with a low voltage, which is received at the gate. The transistor M24 is turned-on when the gate is at a high voltage. The diode D2 may be referred to as a “second diode”. The anode of the diode D2 is at a high voltage, so the diode D2 is forward biased. The source “s” of the switch element S1 is coupled to the terminal b12 of the capacitor Cb1 through the turned-on transistor M24. The gate “g” of the switch element S1 is coupled to the terminal b11 of the capacitor Cb1 through the forward biased diode D1 and the turned-on transistor M22.

In the third transition state of the voltage control device 100, the capacitor Cb1 is charged to the target voltage VDD. The voltage between the terminal b11 and the terminal b12 of the capacitor Cb1 is the target voltage VDD. Therefore, the gate-source voltage Vgs of the switch element S1 is equal to the target voltage VDD. As shown in FIG. 4C, in the third transition state from the time point t2 to the time point t3, the voltage control device 100 modulates the gate-source voltage Vgs of the switch element S1 to the target voltage VDD.

Then, from time point t3 to time point t6, the voltage control device 100 repeats the above-mentioned modulation. The period from time point t3 to time point t4 is the first transition state of the voltage control device 100, in which the capacitor Cb2 is charged to the target voltage V1, and the capacitor Cb1 is charged to the target voltage VDD. The period from time point t4 to time point t5 is the second transition state of the voltage control device 100, and the gate-source voltage Vgs of the switch element S1 is modulated to the target voltage V1. The period from time point t5 to time point t6 is the third transition state of the voltage control device 100, and the gate-source voltage Vgs of the switch element S1 is modulated to the target voltage VDD.

In the embodiments shown in FIGS. 4A-2 to 4D-3, the voltage control device 100 implements a two-stage modulation on the gate-source voltage Vgs of the switch element S1, and modulates the gate-source voltage Vgs into a target voltage V1 and a target voltage VDD respectively (the target voltage V1 and the target voltage VDD are respectively equal to the target voltage Vgs1 and the target voltage Vgs2 in FIG. 2A). In other embodiments, the switched capacitor circuit 1000 may further implement multi-stage modulation on the gate-source voltage Vgs, such as three-stage modulation and four-stage modulation, which are described below.

Please refer to another comparative example (not shown in the figures). This comparative example utilizes a current limiting element or a large resistor to suppress the current spikes. The current limiting element or large resistor is disposed in the current path of the switched capacitor circuit, so as to increase the equivalent resistance value of the current path, such that current spikes can be reduced. However, the current limiting element or a large resistor may cause unnecessary voltage drop and power loss, and hence reduce the output voltage of the switched capacitor circuit.

Please refer to still another comparative example (not shown in the figures). This comparative example utilizes an additional power switch element to modulate the turned-on resistance value associated with the current path. However, the additional power switch element may increase overall volume of the switched capacitor circuit.

In contrast, the switched capacitor circuit 1000 of the present disclosure utilizes the voltage control device 100 to perform modulations on the gate-source voltage Vgs of the switch element(s) to suppress the current spikes. The modulations may be stage time varying modulation or continuous time varying modulation. The switched capacitor circuit 1000 of the present disclosure does not need to dispose extra circuitry elements (e.g., the current limiting element, large resistor or power switch element as in the comparative examples). Accordingly, circuit complexity can be reduced, and output voltage and conversion efficiency can be maintained.

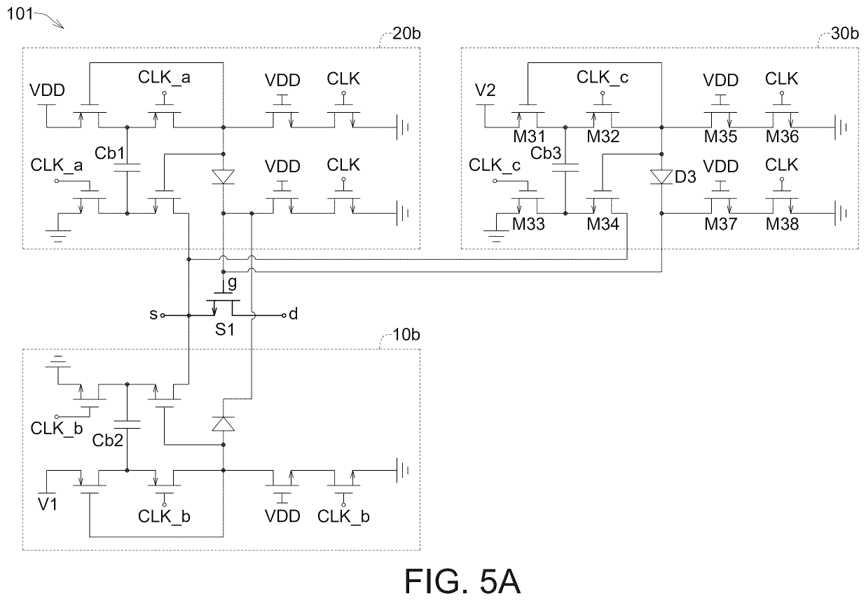

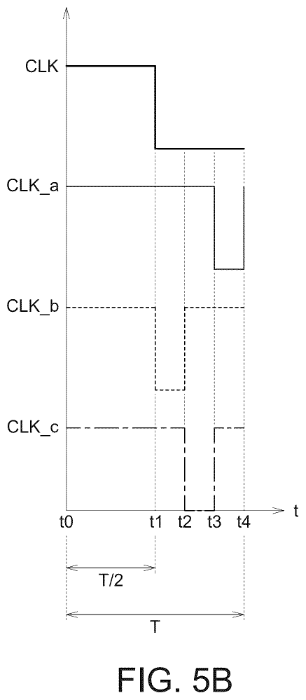

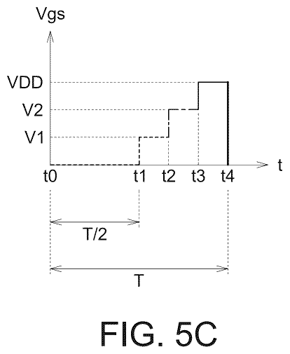

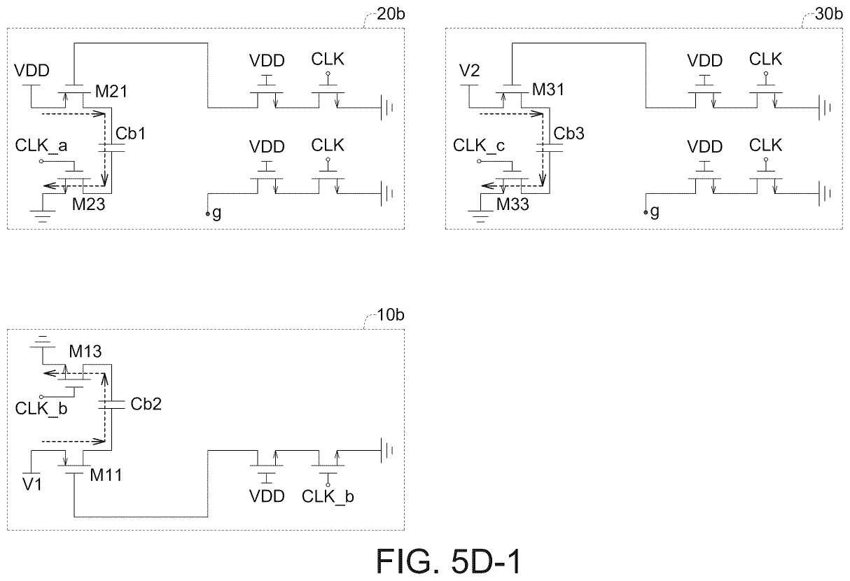

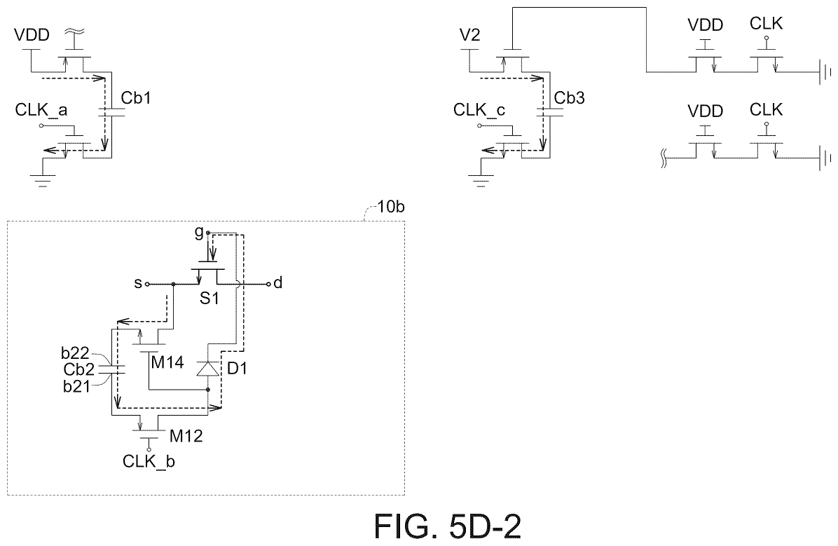

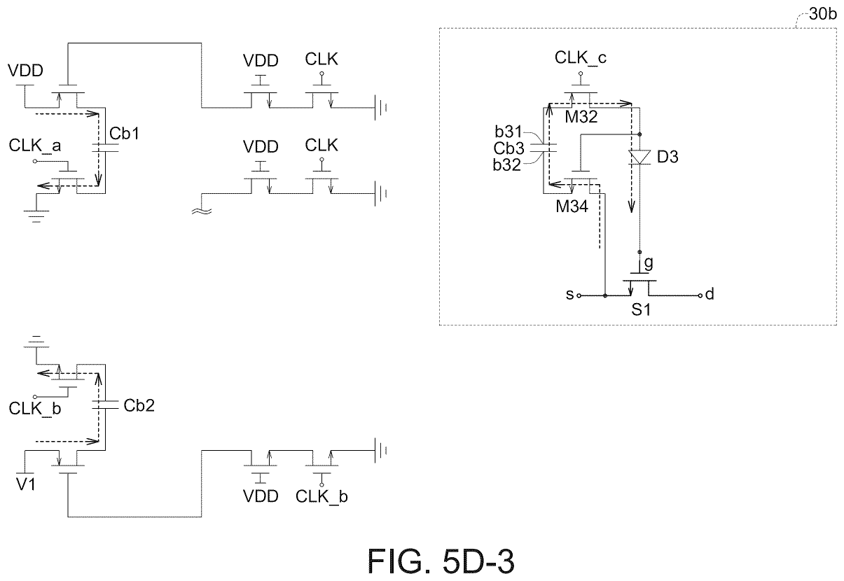

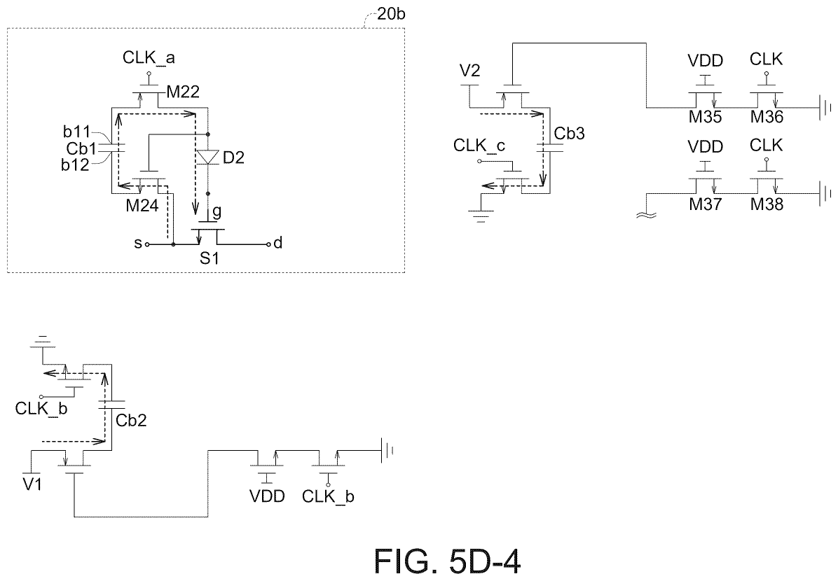

Please refer to FIG. 5A, which shows a circuit diagram of a voltage control device 101 according to another embodiment of the present disclosure. The voltage control device 101 of this embodiment performs three-stage modulation on the gate-source voltage Vgs of the switch element S1. The voltage control device 101 comprises a bootstrap circuit 10b, a bootstrap circuit 20b and a bootstrap circuit 30b.

The bootstrap circuit 10b and the bootstrap circuit 20b are the same as the bootstrap circuit 10 and the bootstrap circuit 20 of the voltage control device 100 of FIG. 4A. The bootstrap circuit 30b is similar to the bootstrap circuit 20b, and is used to modulate the gate-source voltage Vgs of the switch element S1 to a target voltage V2. The bootstrap circuit 30b comprises eight transistors M31-M38, a diode D3 and a capacitor Cb3. The source of the transistor M31 receives the target voltage V2, and the gates of the transistors M32 and M33 receive the multi-stage control signal CLK_c. The drain of the transistor M34 is coupled to the source “s” of the switch element S1. The cathode of the diode D3 is coupled to the gate “g” of the switch element S1. The voltage control device 101 performs three-stage modulation on the gate-source voltage Vgs of the switch element S1 according to the switch control signal CLK, the multi-stage control signals CLK_a, CLK_b and CLK_c.

FIG. 5B shows the waveforms of the switch control signal CLK, the multi-stage control signals CLK_a, CLK_b and CLK_c of the voltage control device 101 of FIG. 5A. Furthermore, FIG. 5C shows the waveform of the gate-source voltage Vgs of the switch element S1 when the voltage control device 101 implements three-stage modulation. As shown in FIGS. 5B and 5C, the voltage control device 101 operates in the first transition state, the second transition state, the third transition state and the fourth transition state. The period from time point t0 to time point t1 is the first transition state, the period from time point t1 to time point t2 is the second transition state, the period from time point t2 to time point t3 is the third transition state, and the period from time point t3 to time point t4 is the fourth transition state. The entire time length from the first transition state to the fourth transition state is the period T. In the first transition state, the capacitor Cb2 of the bootstrap circuit 10b is charged to the target voltage V1, the capacitor Cb3 of the bootstrap circuit 30b is charged to the target voltage V2, and the capacitor Cb1 of the bootstrap circuit 20b is charged to the target voltage VDD. Then, in the second transition state, the third transition state, and the fourth transition state, voltage control device 101 modulates the gate-source voltage Vgs of the switch element S1 to the target voltage V1, the target voltage V2, and the target voltage VDD, respectively.

FIG. 5D-1 is a schematic diagram showing the voltage control device 101 operating in the first transition state. Please refer to FIG. 5B and FIG. 5D-1. In the first transition state, the multi-stage control signals CLK, CLK_a, CLK_b and CLK_c are all high voltages. In the bootstrap circuit 20b, the transistor M21 is turned-on, and the transistor M23 is turned-on in response to the high voltage multi-stage control signal CLK_a. The turned-on transistor M21, the capacitor Cb1, and the turned-on transistor M23 form a conducting path to provide the target voltage VDD to the capacitor Cb1 for charging. Similarly, in the bootstrap circuit 10b, the turned-on transistor M11, the capacitor Cb2, and the turned-on transistor M13 form a conducting path to provide the target voltage V1 to the capacitor Cb2 for charging. Furthermore, in the bootstrap circuit 30b, the turned-on transistor M31, the capacitor Cb3, and the turned-on transistor M33 form a conducting path to provide the target voltage V2 to the capacitor Cb3 for charging.

FIG. 5D-2 is a schematic diagram showing the voltage control device 101 operating in the second transition state. Please refer to FIG. 5B and FIG. 5D-2. The period from time point t1 to time point t2 is the second transition state of the voltage control device 101. The switch control signal CLK and the multi-stage control signal CLK_b are reduced to a low voltage, and the multi-stage control signals CLK_a and CLK_c are maintained at a high voltage. The transistor M12 is turned-on in response to the multi-stage control signal CLK_b, and the gate of the transistor M14 and the anode of the diode D1 are both at high voltages, so the transistor M14 is turned-on and the diode D1 is forward biased. The source “s” and the gate “g” of the switch element S1 are respectively coupled to the terminal b22 and the terminal b21 of the capacitor Cb2 through the transistor M14, the diode D1 and the transistor M12. In the first transition state, capacitor Cb2 is charged to the target voltage V1. Therefore, in the second transition state, the gate-source voltage Vgs between the gate “g” and source “s” of the switch element S1 (respectively coupled to the terminal b21 and the terminal b22 of the capacitor Cb2) is equal to the target voltage V1, to which the capacitor Cb2 is charged. That is, in the second transition state, the voltage control device 101 modulates the gate-source voltage Vgs of the switch element S1 to the target voltage V1.

FIG. 5D-3 is a schematic diagram showing the voltage control device 101 operating in the third transition state. Please refer to FIG. 5B and FIG. 5D-3. The period from time point t2 to time point t3 is the third transition state of the voltage control device 101. The switch control signal CLK and the multi-stage control signal CLK_c are low voltages, and the multi-stage control signals CLK_a and CLK_b are high voltages. The transistor M32 is turned-on in response to the multi-stage control signal CLK_c, and the gate of the transistor M34 and the anode of the diode D3 are at a high voltage, so the transistor M34 is turned-on and the diode D3 is forward biased. The source “s” and the gate “g” of the switch element S1 are respectively coupled to the terminal b32 and the terminal b31 of the capacitor Cb3 through the transistor M34, the diode D3 and the transistor M32. In the first transition state, capacitor Cb3 is charged to the target voltage V2. Therefore, in the third transition state, the gate-source voltage Vgs between the gate “g” and source “s” of the switch element S1 (respectively coupled to the terminal b31 and the terminal b32 of the capacitor Cb3) is equal to the target voltage V2 to which the capacitor Cb3 is charged. That is, in the third transition state, the voltage control device 101 modulates the gate-source voltage Vgs of the switch element S1 to the target voltage V2.

FIG. 5D-4 is a schematic diagram showing the voltage control device 101 operating in the fourth transition state. Please refer to FIG. 5B and FIG. 5D-4. The period from time point t3 to time point t4 is the fourth transition state of the voltage control device 101. The switch control signal CLK and the multi-stage control signal CLK_a are low voltages, and the multi-stage control signals CLK_b and CLK_c are high voltages. The transistor M22 is turned-on in response to the multi-stage control signal CLK_a, and the gate of the transistor M24 and the anode of the diode D2 are at a high voltage, so the transistor M24 is turned-on and the diode D2 is forward biased. The source “s” and the gate “g” of the switch element S1 are respectively coupled to the terminal b12 and the terminal b11 of the capacitor Cb1 through the transistor M24, the diode D2 and the transistor M22. In the first transition state, the capacitor Cb1 is charged to the target voltage VDD. Therefore, in the fourth transition state, the gate-source voltage Vgs between the gate “g” and the source “s” of the switch element S1 (respectively coupled to the terminal b11 and the terminal b12 of the capacitor Cb1) is equal to the target voltage VDD to which the capacitor Cb1 is charged. That is, in the fourth transition state, the voltage control device 101 modulates the gate-source voltage Vgs of the switch element S1 to the target voltage VDD.

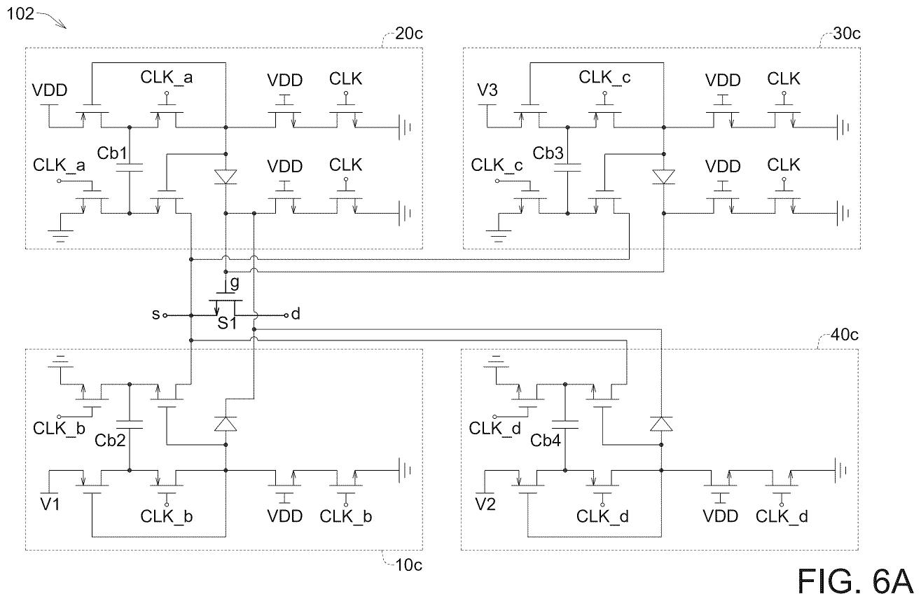

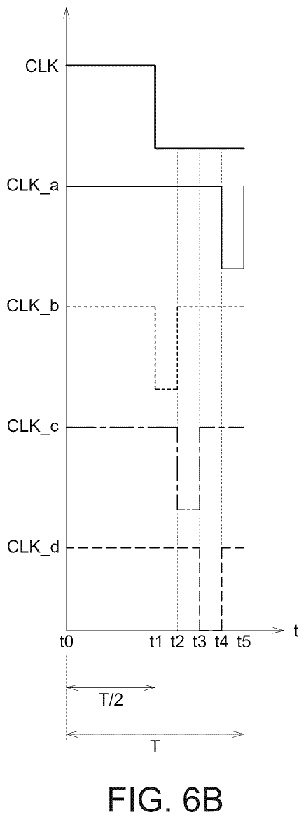

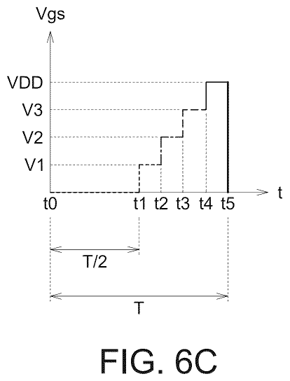

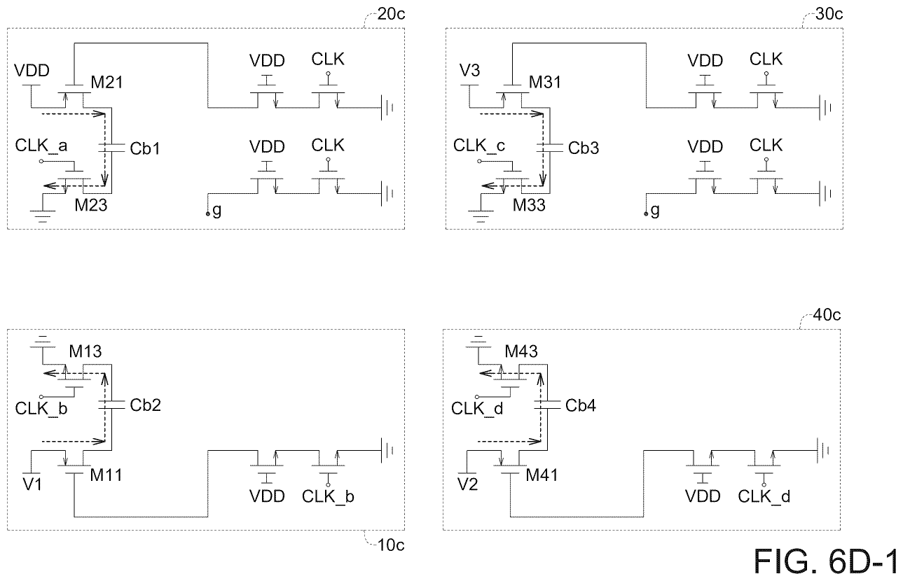

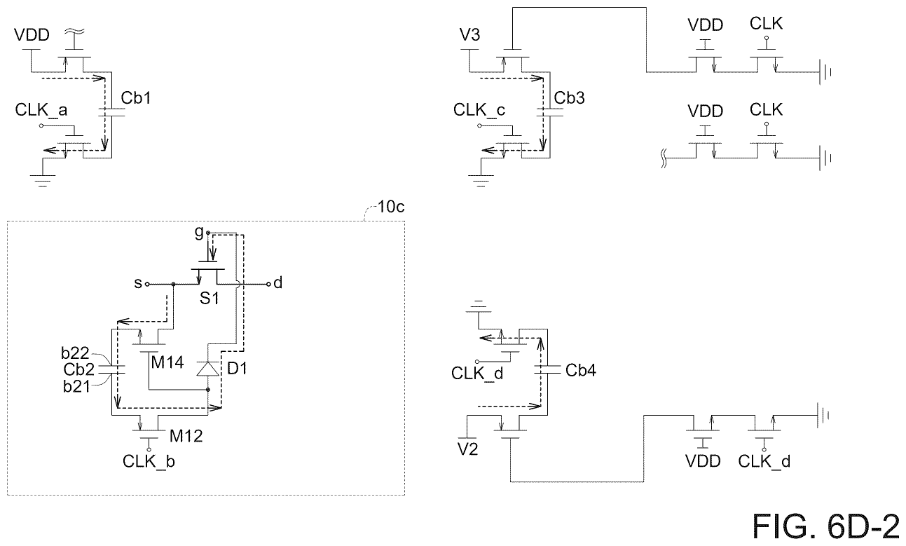

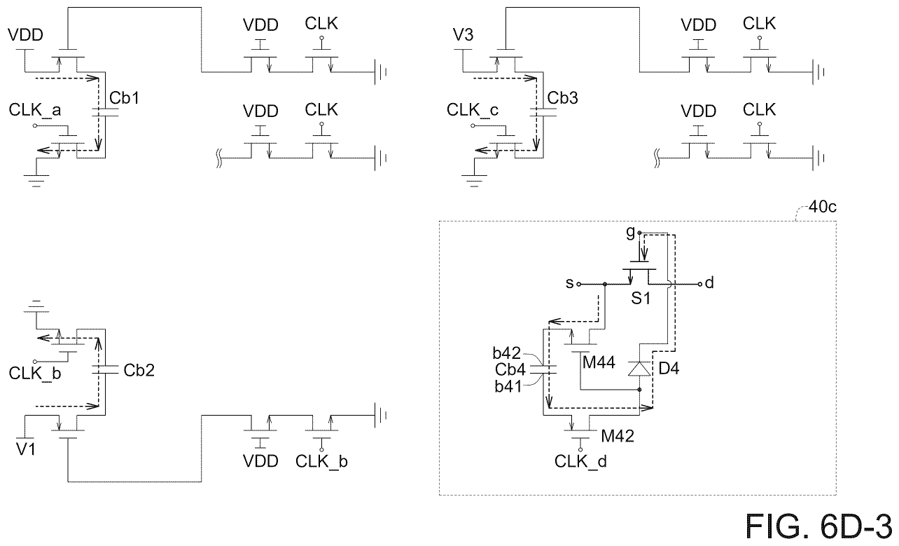

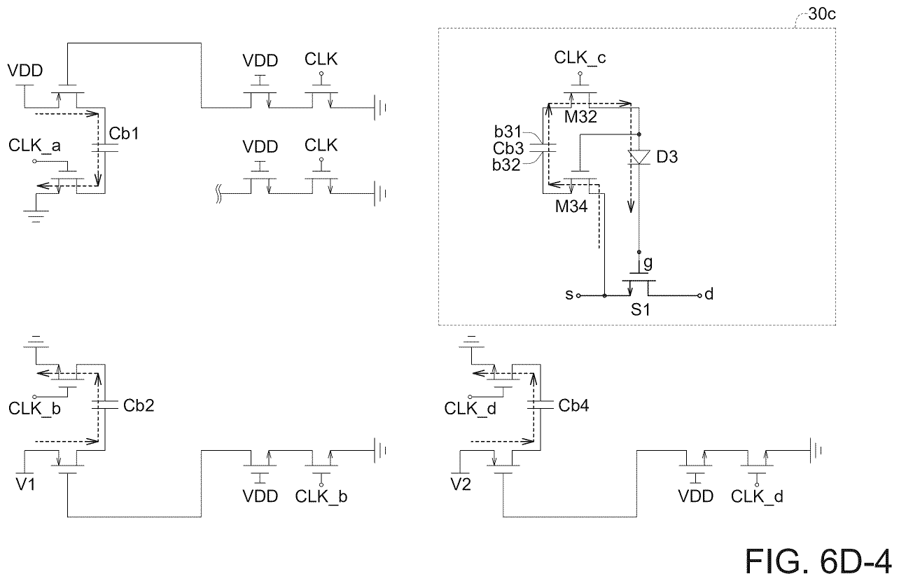

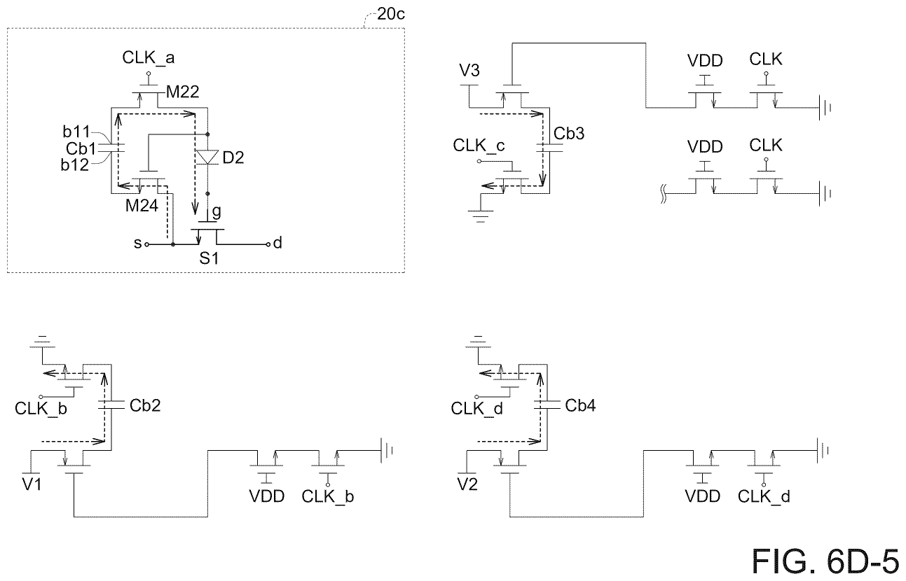

Please refer to FIG. 6A, which shows a circuit diagram of a voltage control device 102 according to another embodiment of the present disclosure. The voltage control device 102 of this embodiment performs four-stage modulation on the gate-source voltage Vgs of the switch element S1. The voltage control device 102 comprises four bootstrap circuits 10c, 20c, 30c and 40c. The bootstrap circuits 10c, 20c and 30c are the same as the bootstrap circuits 10b, 20b and 30b of the voltage control device 101 of FIG. 5A. Also, another bootstrap circuit 40c is similar to the bootstrap circuit 10c. The bootstrap circuits 10c, 20c, 30c and 40c are respectively used to modulate the gate-source voltage Vgs of the switch element S1 to the target voltages V1, VDD, V3 and V2.

The voltage control device 102 performs four-stage modulation on the gate-source voltage Vgs of the switch element S1 according to the switch control signal CLK and the multi-stage control signals CLK_a, CLK_b, CLK_c and CLK_d. The bootstrap circuit 10c operates according to the multi-stage control signal CLK_b, the bootstrap circuit 20c operates according to the switch control signal CLK and the multi-stage control signal CLK_a, the bootstrap circuit 30c operates according to the switch control signal CLK and the multi-stage control signal CLK_c, and the bootstrap circuit 40c operates according to the multi-stage control signal CLK_d.

FIG. 6B shows the waveforms of the switch control signal CLK and the multi-stage control signals CLK_a, CLK_b, CLK_c and CLK_d of the voltage control device 102 of FIG. 6A. Furthermore, FIG. 6C shows the waveform of the gate-source voltage Vgs of the switch element S1 when the voltage control device 102 implements four-stage modulation. As shown in FIGS. 6B and 6C, the voltage control device 102 operates in the first transition state to the fifth transition state. Period from time point t0 to time point t1 is the first transition state, period from time point t1 to time point t2 is the second transition state, period from time point t2 to time point t3 is the third transition state, period from time point t3 to time point t4 is the fourth transition state, and period from time point t4 to time point t5 is the fifth transition state. The entire time length from the first transition state to the fifth transition state is one period (i.e., T).

In the first transition state, the capacitor Cb2 of the bootstrap circuit 10c is charged to the target voltage V1, the capacitor Cb1 of the bootstrap circuit 20c is charged to the target voltage VDD, the capacitor Cb3 of the bootstrap circuit 30c is charged to the target voltage V3, and the capacitor Cb4 of the bootstrap circuit 40c is charged to the target voltage V2. Then, in the second transition state to the fifth transition state, the voltage control device 102 modulates the gate-source voltage Vgs of the switch element S1 to the target voltage V1, the target voltage V2, the target voltage V3 and the target voltage VDD respectively.

FIG. 6D-1 is a schematic diagram showing the voltage control device 102 operating in the first transition state. Please refer to FIG. 6B and FIG. 6D-1. In the first transition state, the switch control signal CLK and the multi-stage control signals CLK_a, CLK_b, CLK_c and CLK_d are all high voltages.

In the bootstrap circuit 20c, in response to the switch control signal CLK and the multi-stage control signal CLK_a with high voltages, the transistors M21 and M23 are turned-on to form a conducting path to provide the target voltage VDD to the capacitor Cb1 for charging. In the bootstrap circuit 10c, in response to the multi-stage control signal CLK_b with high voltage, the transistors M11 and M13 are turned-on to form a conducting path, so as to provide the target voltage V1 to the capacitor Cb2 for charging. Similarly, in the bootstrap circuit 30c, the transistors M31 and M33 are turned-on to form a conducting path to provide the target voltage V3 to the capacitor Cb3 for charging. In the bootstrap circuit 40c, the transistors M41 and M43 are turned-on to form a conducting path, so as to provide the target voltage V2 to the capacitor Cb4 for charging.

Similarly, in the bootstrap circuit 10c, the turned-on transistor M11, the capacitor Cb2 and the turned-on transistor M13 form a conducting path to provide the target voltage V1 to the capacitor Cb2 for charging. Furthermore, in the bootstrap circuit 30b, the turned-on transistor M31, the capacitor Cb3, and the turned-on transistor M33 form a conducting path to provide the target voltage V2 to the capacitor Cb3 for charging.

FIG. 6D-2 is a schematic diagram showing the voltage control device 102 operating in the second transition state. The operation of FIG. 6D-2 is similar to that of FIG. 5D-2. In the bootstrap circuit 10c, the transistors M12 and M14 are turned-on, and the diode D1 is forward biased. The source “s” and the gate “g” of the switch element S1 are respectively coupled to the terminal b22 and the terminal b21 of the capacitor Cb2 through the transistor M14, the diode D1 and the transistor M12. Therefore, the gate-source voltage Vgs of the switch element S1 is modulated to the target voltage V1 at which the capacitor Cb2 is charged. That is, the gate-source voltage Vgs is modulated to the target voltage V1.

FIG. 6D-3 is a schematic diagram showing the voltage control device 102 operating in the third transition state. In the bootstrap circuit 40c, the transistors M42 and M44 are turned-on, and the diode D4 is forward biased. The source “s” and the gate “g” of the switch element S1 are respectively coupled to the terminal b42 and the terminal b41 of the capacitor Cb4 through the transistor M44, the diode D4 and the transistor M42. Therefore, the gate-source voltage Vgs of the switch element S1 is modulated to the target voltage V2 at which the capacitor Cb4 is charged. That is, the gate-source voltage Vgs is modulated to the target voltage V2 in the third transition state.

FIG. 6D-4 is a schematic diagram showing the voltage control device 102 operating in the fourth transition state. The operation of FIG. 6D-4 is similar to that of FIG. 5D-3. In the bootstrap circuit 30c, transistors M34 and M32 are turned-on and diode D3 is forward biased. The source “s” and the gate “g” of the switch element S1 are respectively coupled to the terminal b32 and the terminal b31 of the capacitor Cb3 through the transistor M34, the diode D3 and the transistor M32. Therefore, the gate-source voltage Vgs of the switch element S1 is modulated to the target voltage V3 at which the capacitor Cb3 is charged. That is, the gate-source voltage Vgs is modulated to the target voltage V3 in the fourth transition state.

FIG. 6D-5 is a schematic diagram showing the voltage control device 102 operating in the fifth transition state. The operation of FIG. 6D-5 is similar to that of FIG. 5D-4. In the bootstrap circuit 20c, transistors M24 and M22 are turned-on and diode D2 is forward biased. The source “s” and the gate “g” of the switch element S1 are respectively coupled to the terminal b12 and the terminal b11 of the capacitor Cb1 through the transistor M24, the diode D2 and the transistor M22. Therefore, the gate-source voltage Vgs of the switch element S1 is modulated to the target voltage VDD at which the capacitor Cb1 is charged. That is, the gate-source voltage Vgs is modulated to the target voltage VDD in the fifth transition state.

The embodiments of FIGS. 3 to 6D-5 as above-mentioned implement the stage time-varying modulation of the gate-source voltage Vgs of the switch element S1 (or other switch elements S2-S4 of the switched capacitor circuit 1000) in a digital manner. In other embodiments, the gate-source voltage Vgs may also be modulated in an analog manner, as described below.

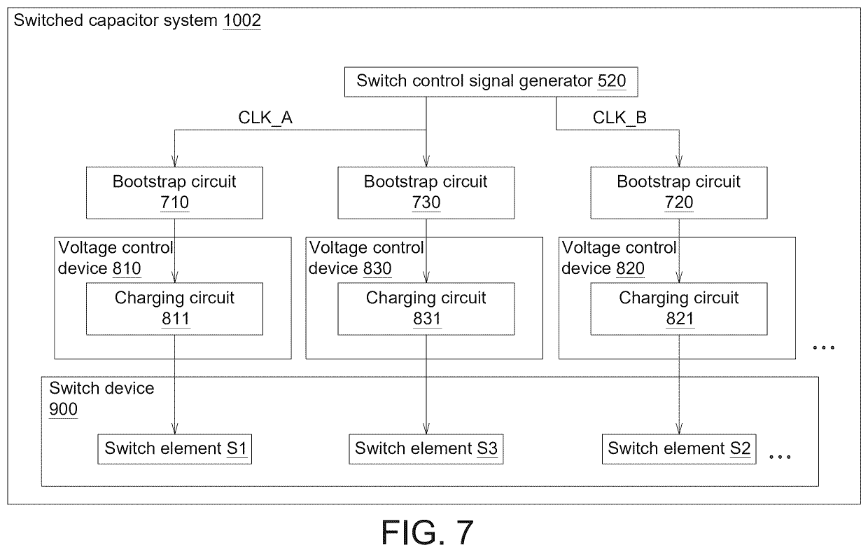

FIG. 7 is a functional block diagram of the switched capacitor system 1002 of the present disclosure. The switched capacitor system 1002 of FIG. 7 performs the function of switched capacitor circuit at a level of overall system. The switched capacitor system 1002 comprises a switch control signal generator 520, a plurality of bootstrap circuits, a plurality of voltage control devices and a switch device 900. The switch device 900 comprises, for example, the switch elements S1 to S4 shown in FIG. 1A. Furthermore, FIG. 7 takes three switch elements S1-S3 as an example for explanation. The bootstrap circuits 710, 720, and 730 and the voltage control devices 810, 820, and 830 correspond to the switch elements S1, S2, and S3.

The modulation of the gate-source voltage Vgs of the switch element S1 is taken as an example for explanation. The switch control signal generator 520 generates a switch control signal CLK_A, which is provided to the bootstrap circuit 710. In response to the switch control signal CLK_A, the bootstrap circuit 710 generates a level shift signal to the charging circuit 811 of the voltage control device 810. In response to the level shift signal, the charging circuit 811 performs a continuous time-varying modulation on the gate-source voltage Vgs of the switch element S1.

Similarly, the switch control signal CLK_A generated by the switch control signal generator 520 is also provided to the bootstrap circuit 730, so that the bootstrap circuit 730 provides a level shift signal to the charging circuit 831 of the voltage control device 830. Furthermore, the charging circuit 831 performs continuous time-varying modulation on the gate-source voltage Vgs of the switch element S3.

On the other hand, the switch control signal generator 520 generates the switch control signal CLK_B with different phases, which is provided to the bootstrap circuit 720, so that the bootstrap circuit 720 provides a level shift signal to the charging circuit 821 of the voltage control device 820. Furthermore, the charging circuit 821 performs continuous time-varying modulation on the gate-source voltage Vgs of the switch element S2.

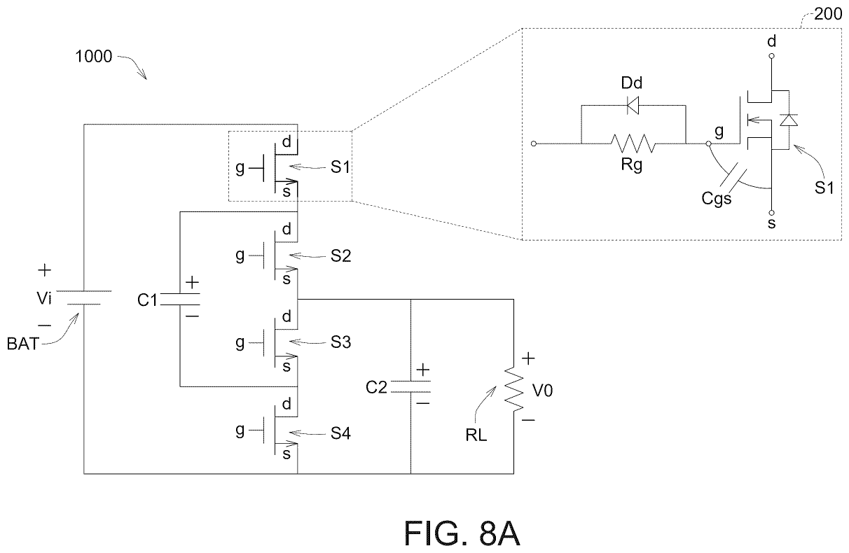

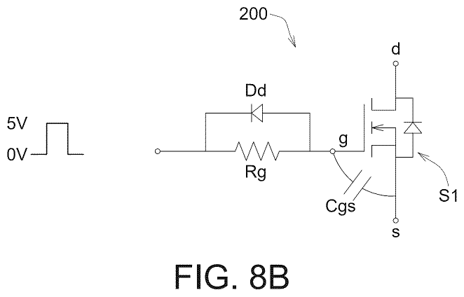

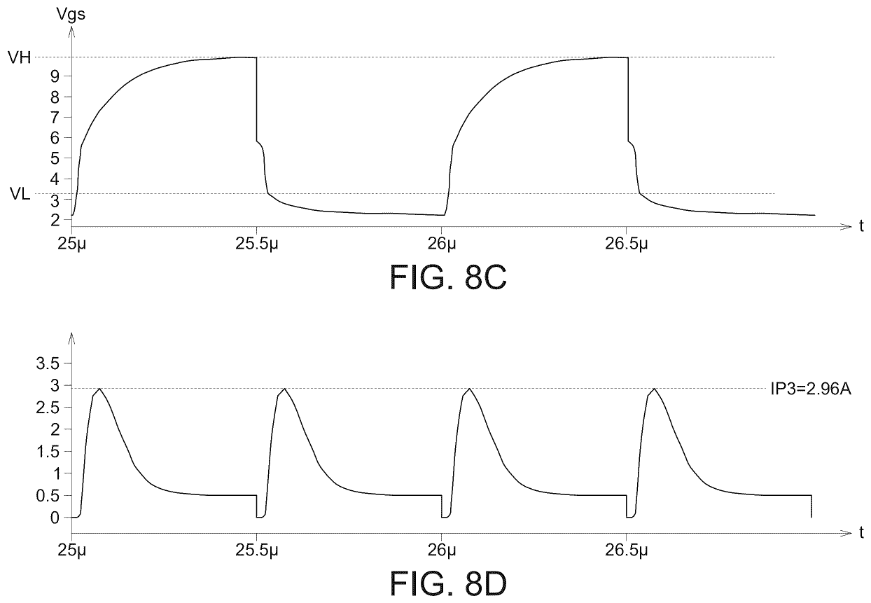

Next, please refer to FIG. 8A, which is a schematic diagram of a voltage control device 200 according to another embodiment of the present disclosure. Each of the switch elements S1-S4 may be provided with a voltage control device 200 to control the voltage of the corresponding switch element. FIG. 8A takes the switch element S1 as an example for explanation. The voltage control device 200 is provided corresponding to the switch element S1, so as to control the gate-source voltage Vgs between the gate “g” and the source “s” of the switch element S1. The voltage control device 200 of FIG. 8A is equivalent to the voltage control device 810 of FIG. 7.

More specifically, the voltage control device 200 performs continuous time-varying modulation (i.e., not for stage time-varying modulation) on the gate-source voltage Vgs of the switch element S1, in an analog manner. The voltage control device 200 comprises a diode Dd and a resistor Rg. The diode Dd is referred to as a “discharge diode” and the resistor Rg referred to as a “gate resistor”. The diode Dd and the resistor Rg are connected in parallel, and the anode of the diode Dd is coupled to the gate “g” of the switch element S1. The resistor Rg and the diode Dd form a resistor-diode circuit (i.e., an RD charging circuit). In other words, the RD charging circuit formed by the resistor Rg and the diode Dd is equivalent to the charging circuit 811 in FIG. 7.

In addition, there is a parasitic capacitance Cgs (also referred to as “gate-source parasitic capacitance”) between the gate “g” and the source “s” of the switch element S1. The voltage control device 200 can operate using the parasitic capacitor Cgs, where the resistor Rg of the voltage control device 200 and the parasitic capacitor Cgs form a resistor-capacitor circuit (i.e., an RC circuit).

FIG. 8B is a schematic diagram showing the operation of the voltage control device 200 in FIG. 8A. FIG. 8C is a waveform diagram of the continuous time-varying modulation of the gate-source voltage Vgs of the switch element S1, when the voltage control device 200 is operating. FIG. 8D is a waveform diagram of the corresponding current change when the gate-source voltage Vgs of the switch element S1 is continuously time-varying modulated. Please refer to FIG. 8B, the gate “g” of the switch element S1 receives a control signal (also referred to as a “third control signal”) through the voltage control device 200, and the switch element S1 switches from the turned-off state to the turned-on state, or from the turned-on state to the turned-off state in response to the control signal. The control signal is, for example, a pulse signal between a low voltage of OV and a high voltage of 5V.

Next, please refer to FIG. 8C and FIG. 8D. The RC circuit formed by the resistor Rg and the parasitic capacitor Cgs has an “RC charging mechanism”. That is, the RC circuit can be charged at a relatively slow charging speed, (namely, “slow charging”). When the control signal rises from a low voltage of OV to a high voltage of 5V, the voltage control device 200 can control the gate-source voltage Vgs of the switch element S1 to rise slowly, by a charging characteristic (i.e., a slow-charging characteristic) of the RC charging mechanism of the RC circuit, which is formed by the resistor Rg and the parasitic capacitor Cgs. Accordingly, in the initial stage when the switch element S1 transits from the turned-off state to the turned-on state, the gate-source voltage Vgs of the switch element S1 is a relatively low voltage, and thus the switch element S1 has a relatively high equivalent turned-on resistance Ron. At this time, the switch element S1 has a lower current, thereby achieving the effect of suppressing the current spike. As shown in FIG. 8D, at the initial stage of the state transition of the switch element S1, the peak value IP3 of the current spike can be suppressed to 2.96 A.

After the initial stage of the state transition of the switch element S1, the gate-source voltage Vgs of the switch element S1 rises to a higher high voltage VH. The switch element S1 has a lower equivalent turned-on resistance Ron which allows a higher current, so as to achieve a higher output power and better voltage conversion efficiency.

Then, the control signal is reduced from a high voltage of 5V to a low voltage of OV, and the switch element S1 transits from a turned-on state to a turned-off state in response to the control signal. When the control signal is reduced from the high voltage 5V to the low voltage OV, according to a charging characteristic (i.e., a fast-discharging characteristic) of the forward bias conduction of the diode Dd, the voltage control device 200 controls the gate-source voltage Vgs of the switch element S1 to drop rapidly to the low voltage VL.

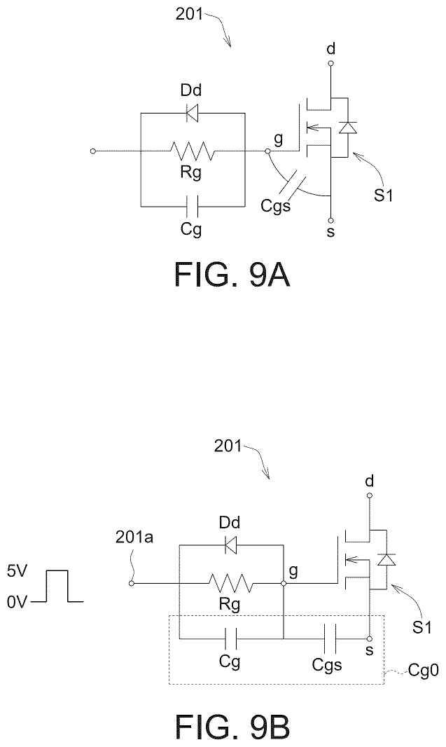

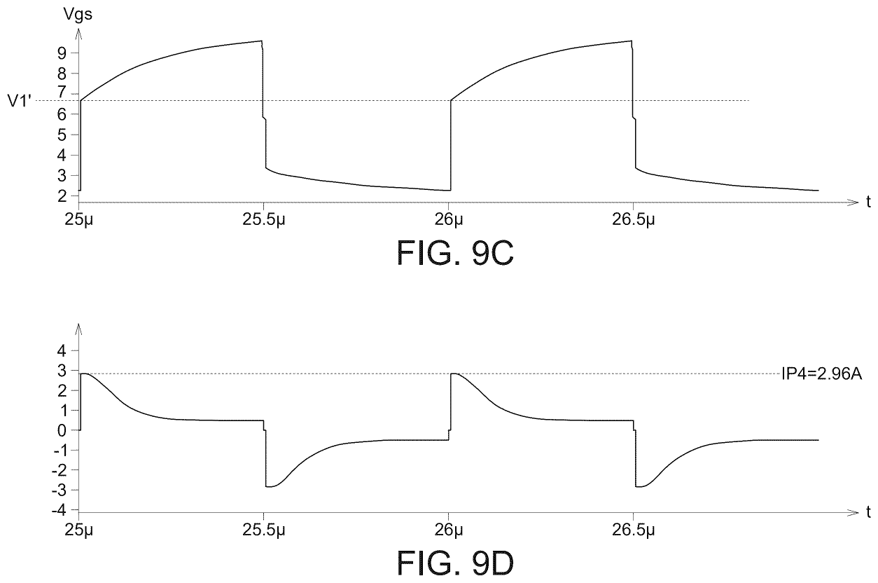

Next, please refer to FIG. 9A, which shows a circuit diagram of a voltage control device 201 according to another embodiment of the present disclosure. The voltage control device 201 of this embodiment is similar to the voltage control device 200 of FIG. 8B, both of which implement continuous time-varying modulation on the gate-source voltage Vgs of the switch element S1 in an analog manner. Compared to the voltage control device 200 in FIG. 8B, the voltage control device 201 of this embodiment further comprises a capacitor Cg. The capacitor Cg is referred to as “gate capacitance”. The capacitor Cg is connected to the diode Dd and the resistor Rg in parallel. The resistor Rg, the capacitor Cg and the diode Dd form a resistor-capacitor-diode circuit (i.e., an RCD charging circuit). In other words, the RCD charging circuit formed by the resistor Rg, the capacitor Cg and the diode Dd is equivalent to the charging circuit 811 in FIG. 7.

FIG. 9B is a schematic diagram showing the operation of the voltage control device 201 in FIG. 9A. The capacitor Cg of the voltage control device 201 is coupled to the parasitic capacitor Cgs of the switch element S1 at a position of the gate “g” of the switch element S1. That is, the capacitor Cg of the voltage control device 201 is connected to the parasitic capacitor Cgs of the switch element S1 in series. The input terminal 201a of the voltage control device 201 receives a control signal, where the control signal rises from a low voltage OV to a high voltage 5V, so as to drive the switch element S1 to transit from a turned-off state to a turned-on state.

Capacitor Cg and parasitic capacitance Cgs are connected in series, so as to form a total capacitance Cg0. The capacitor Cg and the parasitic capacitor Cgs have a ratio of voltage-division. When the control signal rises to a high voltage of 5V, the gate-source voltage Vgs of the switch element S1 rises to a target voltage V1′. The target voltage V1′ is equal to the high voltage 5V of the control signal multiplied by the ratio of voltage-division for the capacitor Cg and the parasitic capacitor Cgs.

FIG. 9C shows a waveform diagram of the continuous time-varying modulation of the gate-source voltage Vgs of the switch element S1 when the voltage control device 201 is operating. FIG. 9D shows a waveform diagram of the current change corresponding to the continuous time-varying modulation of the gate-source voltage Vgs of the switch element S1. Please refer to FIG. 9C and FIG. 9D. When the control signal rises from a low voltage of OV to a high voltage of 5V, the gate-source voltage Vgs of the switch element S1 rises to the target voltage V1′ according to the ratio of voltage-division of the capacitor Cg and the parasitic capacitor Cgs.

Then, according to the slow-charging characteristic of the RC charging mechanism of the RC circuit formed by the resistor Rg and the parasitic capacitor Cgs, the voltage control device 201 achieves a “slow charging” effect, so that the gate-source voltage Vgs of the switch element S1 rises slowly. At the beginning of the transition from the turned-off state to the turned-on state, the switch element S1 has a relatively high equivalent turned-on resistance Ron, and the peak value IP4 of the current spike is suppressed to 2.96 A.

In summary, the voltage control device 201 of FIG. 9A is able to modulate the gate-source voltage Vgs of the switch element S1 to the target voltage V1′ when the state transition of the switch element S1 occurs, being similar to the embodiments of FIGS. 4C, 5C and 6C which modulate the gate-source voltage Vgs to the target voltage V1 in the second transition state. That is, the voltage control device 201 of FIG. 9A has the functions of both continuous time-varying modulation in the analog manner and multi-stage modulation in the digital manner. Furthermore, the voltage control device 201 of FIG. 9A can modulate the target voltage V1′ by changing the ratio of voltage-division for the capacitor Cg and the parasitic capacitor Cgs.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A voltage control device, applied to a switched capacitor circuit, wherein the switched capacitor circuit comprises a plurality of switch elements and a plurality of capacitors, the switch elements comprise at least a first switch element, the first switch element receives a gate-source voltage to control the conduction degree of the first switch element,
wherein, the voltage control device performs at least a stage time-varying modulation or a continuous time-varying modulation on the gate-source voltage of the first switch element, and during the period when the first switch element is turned-on, the gate-source voltage of the first switch element is modulated to a plurality of target voltages at a plurality of time points in response to a set of switch control signals.

2. The voltage control device of claim 1, wherein the stage time-varying modulation corresponds to a plurality of stages and is performed in a multi-stage manner.

3. The voltage control device of claim 2, comprising:
a multi-stage control signal generator, for generating a plurality of multi-stage control signals in response to the set of switch control signals; and
a multi-stage bootstrap circuit, for modulating the gate-source voltage of the first switch element in response to the multi-stage control signals, so that the gate-source voltage is respectively modulated to the target voltages at the time points, wherein the target voltages are multi-stage target voltages.

4. The voltage control device of claim 2, wherein the target voltages comprise a first target voltage, a second target voltage, and a third target voltage, and the stages comprise a first stage, a second stage, and a third stage, and the voltage control device comprising:
a first bootstrap circuit, for modulating the gate-source voltage of the first switch element to the first target voltage in the first stage; and
a second bootstrap circuit, for modulating the gate-source voltage of the first switch element to the second target voltage in the second stage;
wherein, an absolute value of the second target voltage is higher than an absolute value of the first target voltage.

5. The voltage control device of claim 4, wherein the voltage control device is operated in a plurality of transition states, and the first bootstrap circuit comprises a first capacitor, the second bootstrap circuit comprises a second capacitor, and in a first transition state among the transition states, the first capacitor is charged to the first target voltage, and the second capacitor is charged to the second target voltage.

6. The voltage control device of claim 5, wherein the first bootstrap circuit receives a first multi-stage control signal, and the first bootstrap circuit further comprising:
a first control transistor, which is turned-on in the first transition state in response to a high voltage of the first multi-stage control signal,
wherein, a first capacitor among the capacitors receives the first target voltage through the first control transistor.

7. The voltage control device of claim 6, wherein the second bootstrap circuit receives a second multi-stage control signal, and the second bootstrap circuit further comprising:
a second control transistor, which is turned-on in the first transition state in response to a high voltage of the second multi-stage control signal,
wherein, a second capacitor among the capacitors receives the second target voltage through the second control transistor.

8. The voltage control device of claim 7, wherein the transition states further comprises a second transition state and a third transition state;
in the second transition state, a gate and a source of the first switch element are respectively coupled to two ends of the first capacitor, and the gate-source voltage of the first switch element is modulated to the first target voltage; and
in the third transition state, the gate and the source of the first switch element are respectively coupled to two ends of the second capacitor, and the gate-source voltage of the first switch element is modulated to the second target voltage.

9. The voltage control device of claim 8, wherein the first bootstrap circuit further comprising:
a third control transistor, which is turned-on in the second transition state in response to a low voltage of the first multi-stage control signal; and
a first diode, which is forward biased in response to the low voltage of the first multi-stage control signal,
wherein, the gate of the first switch element is coupled to the first capacitor through the third control transistor and the first diode.

10. The voltage control device of claim 8, wherein the second bootstrap circuit further comprising:
a fourth control transistor, which is turned-on in the third transition state in response to a low voltage of the second multi-stage control signal; and
a second diode, which is forward biased in response to the low voltage of the second multi-stage control signal,
wherein, the gate of the first switch element is coupled to the second capacitor through the fourth control transistor and the second diode.

11. The voltage control device of claim 1, when performing the continuous time-varying modulation, the voltage control device modulates the gate-source voltage of the first switch element according to a charging characteristic of a resistor-capacitor circuit.

12. The voltage control device of claim 11, comprising:
a discharge diode, having a cathode coupled to an output terminal of a bootstrap circuit and an anode coupled to the gate of the first switch element; and
a gate resistor, coupled to the gate of the first switch element and connected to the discharge diode in parallel,
wherein, the gate resistor and a gate-source parasitic capacitor of the first switch element form the resistor-capacitor circuit.

13. The voltage control device of claim 12, further comprising:
a gate capacitor, coupled to the gate of the first switch element and connected to the gate resistor and the discharge diode in parallel,
wherein, the gate capacitor, the gate resistor and the gate-source parasitic capacitor of the first switch element form the resistor-capacitor circuit.

14. The voltage control device of claim 12, wherein the voltage control device receives the switch control signal and, based on an RC charging mechanism formed by the resistor-capacitor circuit, the gate-source voltage of the first switch element forms a third multi-stage control signal in response to the switch control signal and is modulated to a third target voltage.

15. The voltage control device of claim 12, wherein a drop of the gate-source voltage of the first switch element is controlled according to a fast-discharging characteristic of a forward bias conduction of the discharge diode.

16. A switched capacitor system, comprising:
a plurality of switch elements, comprising:
a first switch element, receiving a gate-source voltage to control a conduction degree of the first switch element;
a plurality of capacitors;
a switch control signal generator, for generating a set of switch control signals, and each of the switch control signals has a form of high-low voltage; and
the voltage control device of claim 2;
wherein, the switch control signals are provided to the voltage control device, and the voltage control device performs a stage time-varying modulation on the gate-source voltage of the first switch element in response to the switch control signals.

17. A switched capacitor system, comprising:
a plurality of switch elements, comprising:
a first switch element, receiving a gate-source voltage to control a conduction degree of the first switch element;
a plurality of capacitors;
a switch control signal generator, for generating a set of switch control signals, and each of the switch control signals has a form of high-low voltage; and
the voltage control device of claim 11, comprising an analog charge circuit;
wherein, the switch control signals are provided to the voltage control device, and the voltage control device performs a continuous time-varying modulation on the gate-source voltage of the first switch element in response to the switch control signals.
